(19) United States
(12) Patent Application Publication
(10) Pub. No.: US 2026/0156658 A1
(43) Pub. Date: Jun. 4, 2026

(54) SIDELINK CARRIER AGGREGATION PROCEDURES

(71) Applicant: Fraunhofer-Gesellschaft zur Förderung der angewandten Forschung e.V., München (DE)

(72) Inventors: Thomas WIRTH, Berlin (DE); Thomas FEHRENBACH, Berlin (DE); Baris GÖKTEPE, Berlin (DE); Thomas SCHIERL, Berlin (DE); Thomas WIEGAND, Berlin (DE); Cornelius HELLGE, Berlin (DE)

(21) Appl. No.: 19/456,127

(22) Filed: Jan. 22, 2026

Related U.S. Application Data
(63) Continuation of application No. PCT/EP2024/070774, filed on Jul. 22, 2024.

(30) Foreign Application Priority Data
Jul. 25, 2023 (EP) 23187554.3

(51) Int. Cl. H04W 72/25; H04L 5/00

(52) U.S. Cl. CPC H04W 72/25; H04L 5/001; H04L 5/0037

(57) ABSTRACT

A user device, UE, for a wireless communication network, is described. The UE is to communicate with one or more further UEs in the wireless communication network over a sidelink, SL. The UE is configured or preconfigured to support sidelink carrier aggregation, SL-CA, the SL-CA comprising a plurality of component carriers, CCs. The UE is to select the CCs for the SL communication
in accordance with a configuration or pre-configuration of the SL-CA, and/or
based on inter-UE coordination, IuC, information indicating available/preferred or unavailable/not-preferred resources or a collision, e.g., collision indicator, CI.

### CROSS-REFERENCES TO RELATED APPLICATIONS

This application is a continuation of copending International Application No. PCT/EP2024/070774, filed Jul. 22, 2024, which is incorporated herein by reference in its entirety, and additionally claims priority from European Application No. EP 23187554.3, filed Jul. 25, 2023, which is incorporated herein by reference in its entirety.

The present invention relates to the field of wireless communication systems or networks, more specifically to a communication between respective user devices using a sidelink, SL. Embodiments of the present invention concern improvements and enhancements when implementing sidelink carrier aggregation, SL-CA.

### BACKGROUND OF THE INVENTION

FIG. 1 is a schematic representation of an example of a terrestrial wireless network 100 including, as is shown in FIG. 1(A), the core network 102 and one or more radio access networks RAN₁, RAN₂, . . . RAN_{N}. FIG. 1(B) is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. The term base station may refer to an access point, AP, in any of the WiFi standards, e.g., belonging to the IEEE 802.11-familiy. A user may be a stationary device or a mobile device. The wireless communication system may also be accessed by mobile or stationary IoT devices which connect to a base station or to a user. The mobile or stationary devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 1(B) shows an exemplary view of five cells, however, the RANₙ may include more or less such cells, and RANₙ may also include only one base station. FIG. 1(B) shows two users UE₁ and UE₂, also referred to as user device or user equipment, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1(B) shows two further devices 110₁ and 110₂ in cell 106₄, like IoT devices, which may be stationary or mobile devices. The device 110₁ accesses the wireless communication system via the base station gNB₄ to receive and transmit data as schematically represented by arrow 112₁. The device 110₂ accesses the wireless communication system via the user UE₃ as is schematically represented by arrow 112₂. The respective base station gNB₁ to gNBs may be connected to the core network 102, e.g., via the S1 interface, via respective backhaul links 114₁ to 114₅, which are schematically represented in FIG. 1(B) by the arrows pointing to “core”. The core network 102 may be connected to one or more external networks. The external network may be the Internet, or a private network, such as an Intranet or any other type of campus networks, e.g., a private WiFi communication system or a 4G or 5G mobile communication system. Further, some or all of the respective base station gNB₁ to gNBs may be connected, e.g., via the S1 or X2 interface or the XN interface in NR, with each other via respective backhaul links 116₁ to 116₅, which are schematically represented in FIG. 1(B) by the arrows pointing to “gNBs”. A sidelink channel allows direct communication between UEs, also referred to as device-to-device, D2D, communication. The sidelink interface in 3GPP is named PC5. Note, that the term user equipment, UE, or user device may also refer to a station, STA, as used in any of the WiFi standards, e.g., belonging to the IEEE 802.11-familiy.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, and the physical sidelink broadcast channel, PSBCH, carrying for example a master information block, MIB, and one or more system information blocks, SIBs, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. The sidelink interface may support a 2-stage SCI which refers to a first control region containing some parts of the SCI, also referred to as the 1^{st}-stage SCI, and optionally, a second control region which contains a second part of control information, also referred to as the 2^{nd}-stage SCI.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix, CP, length. A frame may also have a smaller number of OFDM symbols, e.g., when utilizing shortened transmission time intervals, sTTI, or a mini-slot/non-slot-based frame structure comprising just a few OFDM symbols.

The wireless communication system may be any single-tone or multicarrier system using frequency-division multiplexing, like the orthogonal frequency-division multiplexing, OFDM, system, the orthogonal frequency-division multiple access, OFDMA, system, or any other Inverse Fast Fourier Transform, IFFT, based signal with or without Cyclic Prefix, CP, e.g., Discrete Fourier Transform-spread-OFDM, DFT-s-OFDM. Other waveforms, like non-orthogonal waveforms for multiple access, e.g., filter-bank multicarrier, FBMC, generalized frequency division multiplexing, GFDM, or universal filtered multi carrier, UFMC, may be used. The wireless communication system may operate, e.g., in accordance with 3GPPs LTE, LTE-Advanced, LTE-Advanced Pro, or the 5G or 5G-Advanced or 3GPPs NR, New Radio, or within LTE-U, LTE Unlicensed or NR-U, New Radio Unlicensed, which is specified within the LTE and within NR specifications.

The wireless network or communication system depicted in FIG. 1 may be a heterogeneous network having distinct overlaid networks, e.g., a network of macro cells with each macro cell including a macro base station, like base station gNB₁ to gNB₅, and a network of small cell base stations, not shown in FIG. 1, like femto or pico base stations. In addition to the above-described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro or 5G or 5G-Advanced or NR, New Radio, or a possible future 6G radio system.

In mobile communication networks, for example in a network like that described above with reference to FIG. 1, like an LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. An RSU may have a functionality of a BS or of a UE, depending on the specific network configuration. Other UEs may not be vehicular related UEs and may comprise any of the above-mentioned devices. Such devices may also communicate directly with each other, D2D communication, using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are necessarily outside one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations or a WiFi AP.

FIG. 2(A) is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a Mode 1 configuration in NR V2X or as a mode 3 configuration in LTE V2X. Thus, in Mode 1, a UE, e.g., UE 202 is connected via Uu interface to the gNB, and the gNB coordinates the resources for UE 202 be used to transmit control and/or data to another UE, e.g., UE 204, via a SL interface, which is referred to in NR as PC5.

FIG. 2(B) is a schematic representation of an out-of-coverage scenario in which the UEs directly communicating with each other are either not connected to a base station, although they may be physically within a cell of a wireless communication network, or some or all of the UEs directly communicating with each other are connected to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a Mode 2 configuration in NR V2X or as a Mode 4 configuration in LTE V2X. As mentioned above, the scenario in FIG. 2(B) which is the out-of-coverage scenario does not necessarily mean that the respective Mode 2 UEs in NR or mode 4 UEs in LTE are outside of the coverage 200 of a base station, rather, it means that the respective Mode 2 UEs in NR or mode 4 UEs in LTE are not served by a base station, are not connected to the base station of the coverage area, or are connected to the base station but receive no SL resource allocation configuration or assistance from the base station. Thus, there may be situations in which, within the coverage area 200 shown in FIG. 2(A), in addition to the NR Mode 1 or LTE Mode 3 UEs 202, 204 also NR Mode 2 or LTE mode 4 UEs 206, 208, 210 are present. In addition, FIG. 2(B), schematically illustrates an out of coverage UE using a relay to communicate with the network. For example, the UE 210 may communicate over the sidelink with UE 212 which, in turn, may be connected to the gNB via the Uu interface. Thus, UE 212 may relay information between the gNB and the UE 210. Thus, the SL-UEs, e.g., UEs 206-210, need not to have a connectivity to the gNB, and perform a sensing & access resource allocation or a random access-based resource allocation, e.g., when transmitting from UE 206 to UE 208. Nevertheless, basic configurations need to be available for the UEs 206-210, in order to successfully exchange data. This information may be pre-configured or may be configured while a UE is within coverage of the gNB. For this the gNB may provide a basic configuration, e.g., basic information, which may be transported via a broadcast channel, e.g., using system information blocks (SIBs). The BS may also assist Mode 2 UEs to provide basic information on which resource pool (RP) is to be used or may act as a synchronization source.

Although FIG. 2(A) and FIG. 2(B) illustrate vehicular UEs, it is noted that the described in-coverage and out-of-coverage scenarios also apply for non-vehicular UEs. In other words, any UE, like a hand-held device, communicating directly with another UE using SL channels may be in-coverage and out-of-coverage.

In general, Mode 1 refers to a RAN-supported operation including base stations, whereas Mode 2 refers to an autonomous mode, where UEs communicate directly without support of a base station. In the context of WiFi, the coordination done by a WiFi access point, AP, may be referred to a similar operation as Mode 1, whereas Mode 2 translates to the WiFi autonomous mode. In the latter, two WiFi devices may directly communicate with each other without assistance by the WiFi AP.

In the above-described scenarios of vehicular user devices, UEs, a plurality of such user devices may form a user device group, also referred to simply as group, and the communication within the group or among the group members may be performed via the sidelink interfaces between the user devices, like the PC5 interface. For example, the above-described scenarios using vehicular user devices may be employed in the field of the transport industry in which a plurality of vehicles being equipped with vehicular user devices may be grouped together, for example, by a remote driving application. Other use cases in which a plurality of user devices may be grouped together for a sidelink communication among each other include, for example, factory automation and electrical power distribution. In the case of factory automation, a plurality of mobile or stationary machines within a factory may be equipped with user devices and grouped together for a sidelink communication, for example for controlling the operation of the machine, like a motion control of a robot. In the case of electrical power distribution, entities within the power distribution grid may be equipped with respective user devices which, within a certain area of the system may be grouped together so as to communicate via a sidelink communication with each other so as to allow for monitoring the system and for dealing with power distribution grid failures and outages.

Initially, sidelink communication, according to Rel-16, was developed to support advanced V2X applications. Proximity based services including public safety and commercial related services were introduced in Rel-17 also including power saving solutions, like partial sensing or Discontinuous Reception, DRX, as well as the introduction of inter-UE coordination, IuC, to improve power consumption for battery limited terminals and reliability of sidelink transmissions. Although NR sidelink has been initially developed for V2X applications, there is a growing interest, for example in the industry, to expand the applicability of NR sidelink to commercial use cases. For commercial use cases or commercial sidelink applications, an increase in the sidelink data rate and the support of new carrier frequencies for the sidelink are considered.

An increased sidelink data rate may be motivated by applications sharing sensor information, like video information between vehicles having a high degree of driving automation. However, commercial use cases may require even higher data rates. An increased data rate may be achieved by supporting sidelink carrier aggregation, SL-CA, and/or allowing the sidelink to use resources in the unlicensed spectrum.

It is noted that the information in the above section is only for enhancing the understanding of the background of the invention and, therefore, it may contain information that does not form conventional technology that is already known to a person of ordinary skill in the art.

Starting from the above, there may be a need for improvements or enhancements of SL-CA a wireless communication system or network.

### BRIEF DESCRIPTION OF THE DRAWINGS

Embodiments of the present invention will be detailed subsequently referring to the appended drawings, in which:

FIG. 1(A)-(B) illustrate a wireless communication network, wherein FIG. 1(A) is a schematic representation of an example of a terrestrial wireless network, and FIG. 1(B) is a schematic representation of an example of a radio access network, RAN;

FIG. 2(A) is a schematic representation of an in-coverage scenario;

FIG. 2(B) is a schematic representation of an out-of-coverage scenario;

FIG. 3(A) illustrates an example of a UE supporting sidelink carrier aggregation, SL-CA, but applying carrier selection for a communication with a further UE;

FIG. 3(B) illustrates an example of UEs supporting sidelink carrier aggregation, SL-CA, and applying carrier aggregation for a communication with a further UE;

FIG. 4(A) illustrates an example of a UE supporting sidelink carrier aggregation, SL-CA, and communicating with further UEs operating only on a single CC;

FIG. 4(B) illustrates an example of a UE supporting sidelink carrier aggregation, SL-CA, and communicating with one UE operating only on a single CC and with another UE supporting SL-CA;

FIG. 5 is a schematic representation of a wireless communication system including a transmitter, like a base station, and one or more receivers, like user devices, UEs, implementing embodiments of the present invention;

FIG. 6 illustrates a user device, UE, according to an embodiment of a first aspect of the present invention;

FIG. 7 illustrates an embodiment of a first aspect of the present invention for transmitting IuC information, like assistance information messages AIMs, for aggregated carriers;

FIG. 8 illustrates a combination of embodiments of the first aspect implementing cast-type specific component carriers and employing IuC information;

FIG. 9 illustrates a user device, UE, according to an embodiment of a second aspect of the present invention;

FIG. 10 illustrates a user device, UE, according to an embodiment of a third aspect of the present invention;

FIG. 11 illustrates an embodiment of the third aspect of the present invention applying pre-emption of a periodic transmission to perform a carrier selection for a high high-priority transmission;

FIG. 12 illustrates another embodiment of the third aspect of the present invention applying pre-emption of a periodic transmission to perform a high priority transmission on aggregated carriers;

FIG. 13 illustrates a user device, UE, according to an embodiment of fourth aspect of the present invention;

FIG. 14 illustrates an embodiment for implementing data duplication using the UE of FIG. 13;

FIG. 15(A)-(C) illustrates an intra-band contiguous CA, an intra-band, non-contiguous CA and an inter-band non-contiguous CA;

FIG. 16 illustrates a wireless communication network comprising sidelink user devices, UEs, operating in accordance with embodiments of the present invention using resources from the licensed spectrum and/or from the unlicensed spectrum; and

FIG. 17 illustrates an example of a computer system on which units or modules as well as the steps of the methods described in accordance with the inventive approach may execute.

### DETAILED DESCRIPTION OF THE INVENTION

Embodiments of the present invention are now described in more detail with reference to the accompanying drawings, in which the same or similar elements have the same reference signs assigned.

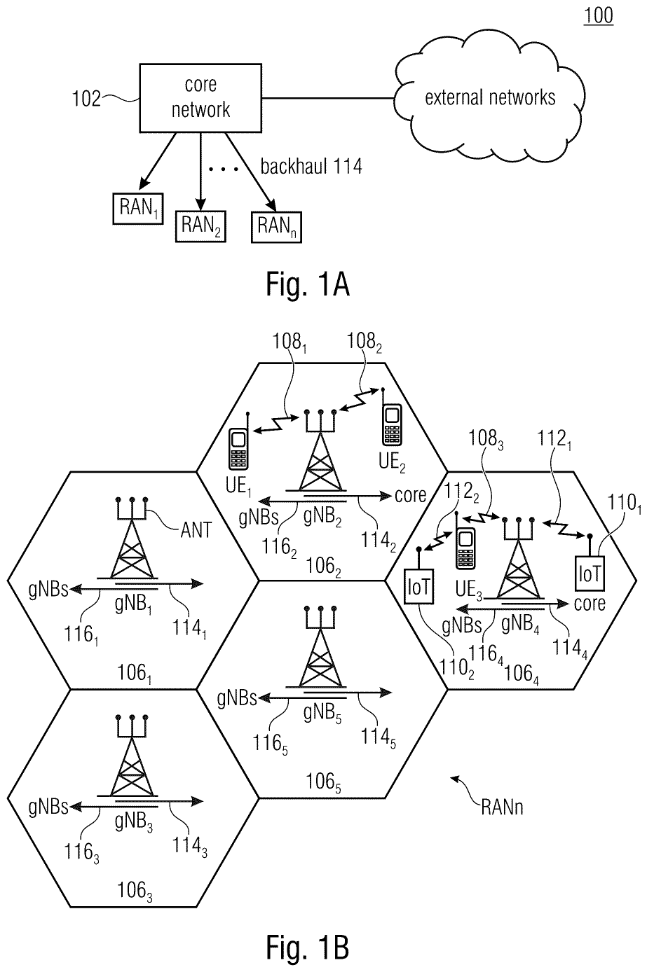

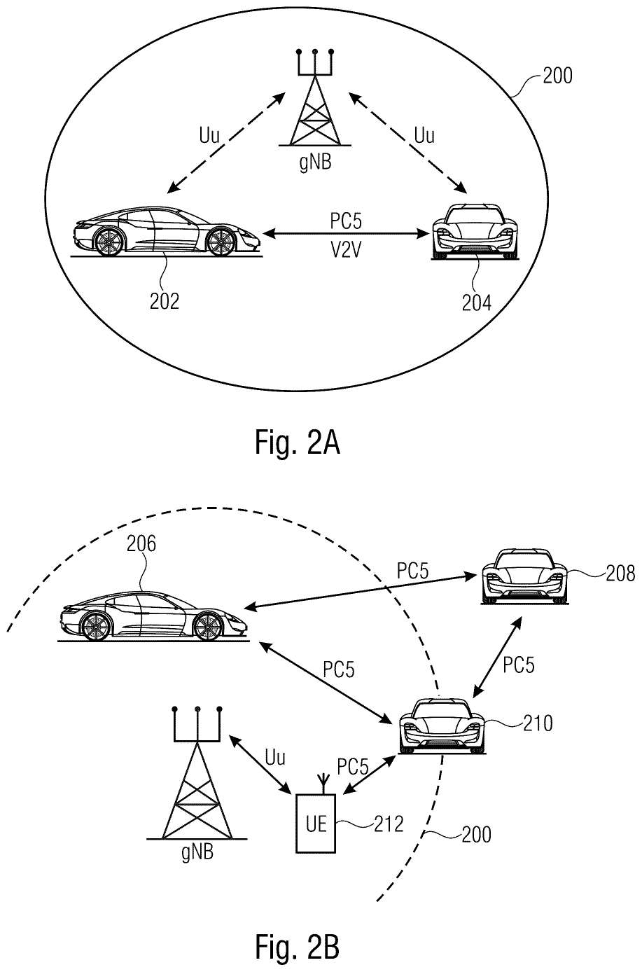

In a wireless communication system network, like the one described above with reference to FIG. 1 and FIG. 2, a sidelink communication may be implemented among a plurality of user devices, UEs. The sidelink communication may support sidelink carrier aggregation, SL-CA. Conventionally, one of the candidate bands for the carrier aggregation on the sidelink is the NR band n47 which is a target band for V2X services, for example, services including the exchange of safety messages, e.g., cooperative awareness messages, CAMs, or decentralized environmental notification messages, DENMs. Carrier aggregation, CA, may be required in certain areas of the world by regulation since some of the carriers are regulated to allow only transmissions using a 10 MHz bandwidth. This may be the case if other technologies are specified for these bands as well which are limited to operate in the 10 MHz spectrum only, e.g., IEEE 802.11p. The following table illustrates the possible CA candidate band for V2X services.

| NR V2X | | | | | |
|---|---|---|---|---|---|
| intra-band | | | Channel | Maximum | |
| concurrent | | | bandwidth | aggregated | Bandwidth |
| operating | NR | Inter- | (MHz) | bandwidth | combination |
| configuration | Band | face | (NOTE 1) | (MHz) | set |
| SL_n47B | n47 | PC5 | 10, 20, 30, 40 | 70 | 0 |
| | n47 | | 10, 20, 30 | | |

(NOTE 1):
The SCS of each channel bandwidth for NR band refers to Table 5.3.5-1 in TS38.101-1.

Implementing carrier aggregation, CA, may include a carrier selection where two UEs select the same component carrier to perform a transmission and a reception. This may be achieved by the transmitting UE which selects one of the component carriers for performing a transmission of control and/or user data, for example via the PSSCH, and the receiving UE performs blind decoding on one or more of the potential sidelink component carriers. Once the receiving UE detects control data on a component carrier it may select the same component carrier to transmit a feedback, for example if the PSFCH is enabled on this component carrier, or it may transmit data on this component carrier to the transmitting UE or to another UE, for example in case the receiving UE also has data to be transmitted. It is expected that component carriers may be used independently such that control transmissions/data transmissions/feedback transmissions are confined to the same component carrier thereby avoiding the need for a management of such transmissions across different carriers, also referred to as cross-carrier scheduling. Furthermore, a resource selection on a particular component carrier may be done based on a channel busy ratio, CBR, threshold to select particular resources of a given quality so that a UE may expect to successfully transmit on the respective component carrier.

For some transmissions, a UE may prefer to transmit via carrier selection which allows the UE to transmit using its full transmit power on a smaller bandwidth which may increase the power spectral density. In case a UE aggregates bandwidth, the power needs to be split among the involved component carriers. This split of power may depend on the component carriers aggregated, the resources used on the component carriers and on the modulation and coding scheme and/or a MIMO mode used on the component carriers. A particular UE may refrain from applying carrier aggregation in case the resources on a given component carrier are polluted, e.g., are interfered by other transmissions, which may be measured by the CBR. For example, when the CBR thresholds on two component carriers are fulfilled for a particular number of resources, e.g., are above a pre-defined CBR threshold, the UE may aggregate more than one component carrier and perform independent transmissions on both carriers.

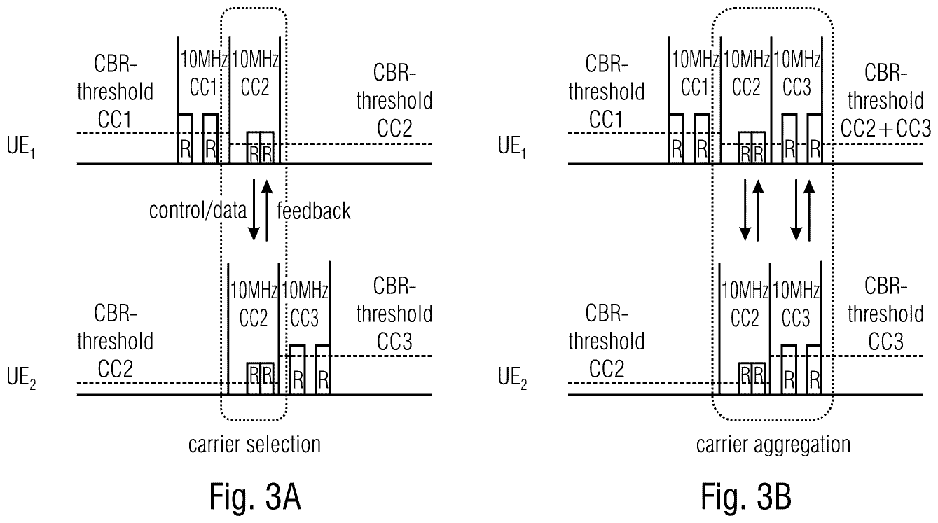

FIG. 3 illustrates the above-mentioned carrier selections versus carrier aggregation. FIG. 3 illustrates two user devices, UE1, UE2 which communicate with each other over the sidelink and which support SL-CA. The respective component carriers, CCs, used by the respective UEs are illustrated and are assumed to be 10 MHz component carriers. Also, the actual resources R used within the respective component carriers for performing the transmissions are illustrated. UE1 is assumed to be the transmitting UE transmitting control/data towards UE2, the receiving UE, which may return to UE1 feedback information, as is illustrated by the respective arrows pointing from UE1 to UE2 and from UE2 to UE1, respectively. Also, the CBR thresholds for the respective CCs are illustrated by the dashed horizontal lines which, for the respective CCs may be different, e.g., dependent on the channel quality required for a transmission, e.g., based on an modulation and coding scheme level, MCS level, or based on a transmission range which may require a certain resource quality, in order to transmit with a said MCS level also with respect to the transmit power and reach a particular UE, which in return may decode the data stream received with a certain SNR or SINR, above a certain interference and/or noise level. Furthermore, CBR thresholds may also be chosen according to a priority of a resource, e.g., a sidelink priority threshold, such that only resources which have a CBR above a certain priority threshold may be chosen for a transmission yielding a high priority class, e.g., for data with an ultra-low delay and/or high reliability requirement. As may be seen, not all of the available resources within a CC fulfill the CBR threshold and only those resources R actually exceeding the CBR threshold are illustrated and are used or are resource candidates to be used for the communication. This means that it is also possible for a UE to select a subset of resource candidates that exceed a CBR threshold, e.g., in case the said UE may already find enough resources for its transmission from the set of candidates. This also depends on the quota, e.g., defined by the corresponding 5QI-value, required for a particular transmission. This resource selection may imply that the said UE performs carrier switching, e.g., in case it finds enough resources on a certain carrier and does not have transmit on a further carrier. In this case, the UE may save transmit power, since it may avoid performing further sensing and transmission on a certain component carrier.

FIG. 3(A) illustrates the above approach of a carrier selection. UE1 supports SL-CA and, basically, may aggregate two component carriers CC1 and CC2. Within the respective component carriers only some of the available resources R exceed the CBR threshold so that only such resources are available for the SL communication while the remaining resources (not illustrated), which are below the CBR threshold, are not used. UE2 also supports carrier aggregation and aggregates component carriers CC2 and CC3 and, as is also depicted, within the respective CCs only the resources R exceeding the respective CBR threshold are employed. When implementing carrier selection, UE1 selects only a single CC among the available CCs, for a communication with UE2. UE1, in the depicted example, selects CC2 for the communication with UE2 for sending control/data towards the UE2 which, accordingly, receives the transmissions also on CC2. UE2 also applies carrier selection and returns a feedback using CC2.

On the other hand, when applying carrier aggregation, as is depicted in FIG. 3(B), UE1, in addition to CC1 and CC2 may also employ a further component carrier CC3. UE₁ may transmit on CC2 and CC3 to UE2, and the transmissions may be independent from each other while UE2 may return a feedback also independent on CC2 and CC3.

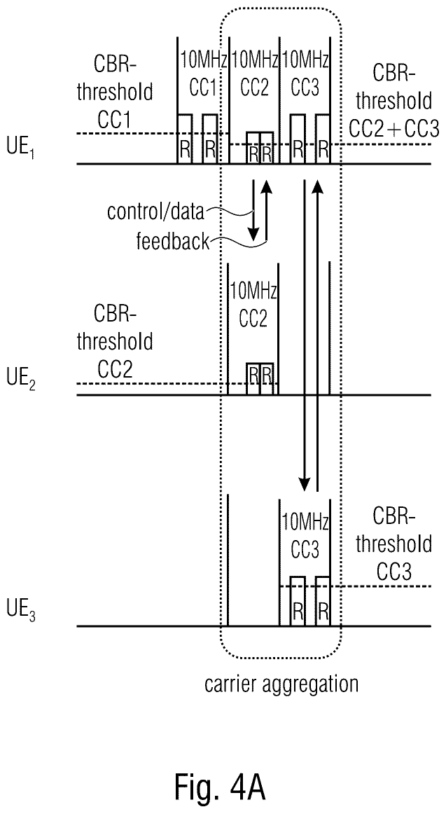

The component carriers may also be used in a mixed mode where one of the UEs transmits using SL-CA while a receiving UE only decodes one of the component carriers. FIG. 4 illustrates examples of such a mixed mode operation. In FIG. 4 UE1 is assumed to support SL-CA by aggregating three component carriers CC1 to CC3 each having a bandwidth of 10 MHz and employing for a SL-communication resources R from the respective CCs exceeding the CBR threshold. In FIG. 4(A) a scenario is illustrated in which UE1 communicates with two further UEs, UE2 and UE3, both operating only on a single CC, namely on CC2 and on CC3, respectively, using resources R exceeding the respective CBR thresholds which are illustrated by the dashed horizontal lines. In the example of FIG. 4(A), UE1 transmits/receives independent on the CC2 and the CC3 to/from UE2 and UE3, respectively. More specifically, using CC2, UE1 performs control/data transmissions towards UE2 and, on the same CC receives the feedback from UE2. Independent from the communication on CC2, UE1 communicates on CC3 with UE3 for performing control/data transmissions from UE1 to UE3 and for receiving feedback transmissions from UE3, as is illustrated by the respective arrows.

In the scenario of FIG. 4(B) it is assumed that also UE2 supports carrier aggregation and employs CC2 and CC3, more specifically those resources R in the respective CCs which exceed the CBR threshold. In this scenario, UE2 receives, on CC2, a control/data transmission from UE1 and returns the feedback transmission while, independently, on CC3 performs a control/data transmission to UE3 and receives from UE3 the feedback transmission.

Thus, as is depicted in FIG. 4, certain UEs may transmit and/or receive only on a subset of the available CCs which may depend on the capability of a UE or the available battery power of the UE or the distance, e.g., path loss, between both UEs. For example, a UE performing power saving may refrain from transmissions on too many CCs, and may limit its processing to a subset of carriers where it expects to receive messages with a given priority, like basic safety messages, BSM.

As may be seen from the above, when implementing SL-CA, how to use the available component carriers may depend on a number of circumstances or on a certain scenario and, conventionally, when implementing SL-CA, the UE simply makes use of the available component carriers which is not very flexible and may not be suited for all circumstances or scenarios encountered by the UE. Therefore, there is a need for providing improvements/enhancements when implementing SL-CA, and the present invention addresses this issue by providing the subsequently outlined aspects improving the operation of a UE supporting SL-CA so as to allow to UE to decide about the CCs to be used when encountering certain circumstances or scenarios. Furthermore, in case of non-contiguous CA, a UE performing CA may select the carrier according to its propagation characteristic, e.g., by selecting a CC in a low frequency band, e.g., with a center frequency below 1 GHz, in order to increase the coverage of a certain message. This may be of relevance when transmitting safety-related information, e.g., BSM.

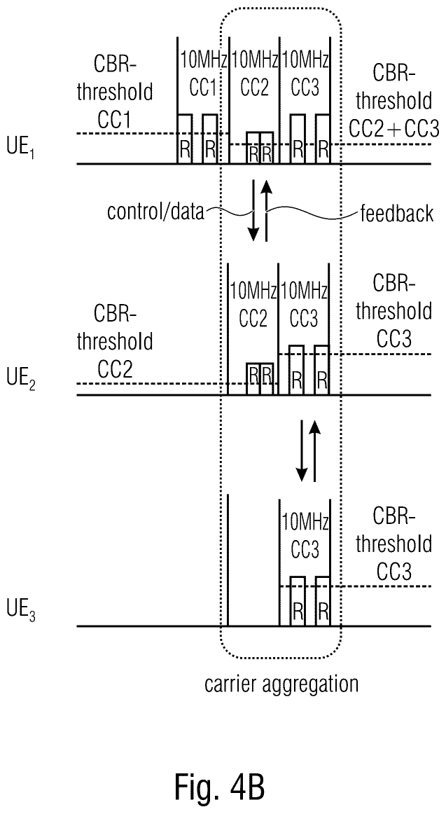

Embodiments of the present invention may be implemented in a wireless communication system as depicted in FIG. 1, FIG. 2(A) or FIG. 2(B) including base stations and users, like mobile terminals or IoT devices. FIG. 5 is a schematic representation of a wireless communication system 310 including a transmitter 300, like a base station, and one or more receivers 302, 304, like user devices, UEs. The transmitter 300 and the receivers 302, 304 may communicate via one or more wireless communication links or channels 306a, 306b, 308, like a radio link. The transmitter 300 may include one or more antennas ANT_{T} or an antenna array having a plurality of antenna elements, a signal processor 300a and a transceiver 300b, coupled with each other. The receivers 302, 304 include one or more antennas ANT_{UE} or an antenna array having a plurality of antennas, a signal processor 302a, 304a, and a transceiver 302b, 304b coupled with each other. The base station 300 and the UEs 302, 304 may communicate via respective first wireless communication links 306a and 306b, like a radio link using the Uu interface, while the UEs 302, 304 may communicate with each other via a second wireless communication link 308, like a radio link using the PC5 or sidelink, SL, interface. When the UEs are not served by the base station or are not connected to the base station, for example, they are not in an RRC connected state, or, more generally, when no SL resource allocation configuration or assistance is provided by a base station, the UEs may communicate with each other over the sidelink. The system or network of FIG. 5, the one or more UEs 302, 304 of FIG. 5, and the base station 300 of FIG. 5 may operate in accordance with the inventive teachings described herein.

### First Aspect

In accordance with a first aspect of the present invention a UE is provided which supports SL-CA and which selects the CCs for a SL communication in accordance with a configuration or pre-configuration of the SL-CA and/or based on an inter-UE coordination, IuC.

In accordance with the first aspect of the present invention, the above drawbacks in conventional approaches are addressed in that the UE which supports SL-CA may determine on the basis of the configuration or pre-configuration of the SL-CA specifics associated with the respective component carriers allowing the UE to determine for a certain scenario or when certain circumstances apply, which of the CCs are suited for performing a SL communication. For example, on the basis of the information defined by the SL-CA configuration, the UE may determine whether a certain CC fulfills the requirements for performing a transmission on the sidelink in accordance with pre-defined transmission parameters or requirements, like a sufficient bandwidth or the like for achieving a desired QoS, quality of service, or for example whether specific information, like feedback information may be received on the component carrier or is received on another component carrier. Moreover, when applying, either alternatively or in addition, also the IuC information, i.e. information about available/preferred or non-available/non-preferred resources or information about collisions on certain resources, e.g., signaled by transmission of a collision indicator, CI, the UE may determine, for example in high interference situations, that certain component carriers are not suited for a communication over the sidelink causing the UE to select only those component carriers which are suitable thereby improving the communication of the SL.

The present invention provides a user device, UE, for a wireless communication network,
wherein the UE is to communicate with one or more further UEs in the wireless communication network over a sidelink, SL,
wherein the UE is configured or preconfigured to support sidelink carrier aggregation, SL-CA, the SL-CA comprising a plurality of component carriers, CCs, and
wherein the UE is to select the CCs for the SL communication
   in accordance with a configuration or pre-configuration of the SL-CA, and/or
   based on inter-UE coordination, IuC, information indicating available/preferred or unavailable/not-preferred resources or a collision, e.g., collision indicator, CI.

In accordance with embodiments, the configuration or pre-configuration of the SL-CA indicates one or more of the following:
one or more properties of a given CC,
among the plurality of CCs one or more CCs containing a predefined signal or predefined information,
one or more CCs to be used for a predefined scenario.

In accordance with embodiments, the one or more properties comprise one or more of the following:
a center frequency of the given CC;
a bandwidth of the given CC,
a bandwidth part, BWP, to be used on the given CC,
a bandwidth class the given CC,
a fallback group
a numerology for the given CC,
a resource pool configuration for a given CC,
a cast type to be used on the given CC, e.g., a broadcast, a groupcast, a multicast or a unicast,
a service type to be used on the given CC,
a transmission priority to be used on the given CC,
whether feedback is enabled on the given CC, e.g., whether a feedback channel, like a Physical Sidelink Feedback Channel, PSFCH, is present on the given CC,
among the plurality of CCs one or more CCs to be used for a feedback in case a feedback, like a Physical Sidelink Feedback Channel, PSFCH, is not enabled on the given CC,
among the plurality of CCs one or more CCs being legacy CCs, that are monitored by legacy UEs,
a UE type to be used on a given CC, e.g., any of V2X-UE, IoT-UE, RSU, relay node,
an NR release type to be usable/allowed for a given CC, e.g., NR Release 17 V2X feature allowed and/or NR Release 18 features allowed, or whether this CC is only used for a certain 3GPP release type, e.g., Rel-16, in order to ensure backwards compatibility,
whether a UE can perform power saving, e.g., DRX or eDRX on the given CC or not, as well as a possible DRX configuration for the given CC,
whether IuC is enabled or disabled on the given CC,
whether the transmission and/or reception of wake-up signals (WUS) is enabled/disabled on the given CC,
whether positioning reference signals, e.g., PRS, can be transmitted on a given CC.

In accordance with embodiments, the predefined signal comprises one or more of the following:
a data signal,
a control signal,
a feedback signal,
one or more synchronization signals,
certain synchronization preambles for a re-synchronization, e.g., to be used in case the UE requires re-synchronization,
a wake-up signal (WUS),
a positioning reference signal (PRS),
a narrowband signal, e.g., a NB-IoT signal,
a beam management-related information,
a measurement signal, e.g., a signal containing channel state information, CSI, or channel quality related information.

In accordance with embodiments, the predefined information comprises one or more of the following:
an interference threshold for a given CC, e.g., a CBR threshold or a non-empty set of CBR thresholds valid for the one, some, or all CCs,
beam management information, beam maintenance information or beam recovery related information,
control information on a particular CC used for Uu, e.g., containing information in case the UE wants to switch from a Mode 2 operation to a Mode 1 operation or vice versa, or in case the UE wants to switch from SL to Uu or to a connection using a relay node, e.g., a Relay UE,
information related to a handover or to a conditional handover, CHO,
paging-related information,
discovery-related information,
broadcast-related information, e.g., a broadcast control channel,
IuC-related information, e.g., AIMs.

In accordance with embodiments, the configuration or pre-configuration of the SL-CA indicates among the plurality of CCs a proper subset of CCs containing the predefined signal or the predefined information.

In accordance with embodiments, the configuration or pre-configuration of the SL-CA indicates among N CCs, N being an integer, from 1 to up to N-1 CCs containing the predefined signal or the predefined information.

In accordance with embodiments, the configuration or pre-configuration of the SL-CA indicates among the plurality of CCs only one CC containing the predefined signal or the predefined information.

In accordance with embodiments, when the configuration or pre-configuration of the SL-CA indicates one or more CCs to be used in a predefined scenario, one or more of the following is indicated:
CCs to be used dependent on a position of the UE,
CCs to be used dependent on the mobility state of the UE,
one or more CCs to be used in case the UE or a further UE with which the UE is to communicate over the SL is not able to transmit or receive on a certain CC,
one or more CCs to be used in case of a unicast link establishment by the UE.

In accordance with embodiments, the CCs to be used dependent on a position of the UE comprise one or more of the following:
CCs to be used dependent on a distance between the UE and a further UE with which the UE is to communicate over the SL, e.g., as defined in the minimum required communication range (MCR),
CCs to be used in a certain geolocation or zone,
CCs to be used dependent on a location of the UE in the wireless communication network.

In accordance with embodiments, the mobility state is one or more of
velocity of a UE,
mode 1 connectivity of a UE, e.g., connected to a certain gNB,
mode 2 connectivity of a UE,
height of a UE or 2D or 3D trajectory of a UE, e.g., in case the UE is a drone,
type of track, e.g., a UE moving on the Autobahn or on a dirt road, railroad track, water road,
a transition state, e.g., the UE performing a handover, e.g., HO or CHO, between gNBs, e.g., for UEs having a connectivity to eNB or gNB.

In accordance with embodiments, wherein the UE is to receive the IuC information from one or more of the following:
one or more of the further UEs not being a communication partner of the UE for a certain SL communication,
one or more of the further UEs being a communication partner of the UE for a certain SL communication, e.g., a UE to/from which the UE transmits/receives over the SL,
a different transceiver in the device (in device coexistence), e.g., the device has internal an LTE and NR modem, or a WiFi modem and an NR modem, and the other UE device forwards this information internally to the UE,
a radio access network, RAN, entity, like a Road Side Unit, RSU, or a gNB or a relay node.

In accordance with embodiments, the IuC-related information is valid and/or received within a selection window of the UE and/or the further UE.

In accordance with embodiments, the UE is to transmit IuC information to a further UE to do one or more of
inform the further UE about one or more future transmissions by the UE,
inform the further UE about resource collisions, e.g., caused by other transmissions,
inform the further UE about preferred resources or non-preferred resources, e.g., resources which are interference-free or which may cause interference to the UE,
request IuC information from the further UE,
a request for positioning information, e.g., a geolocation or reference signals, PRS,
a wake-up signal (WUS),
a mobility state,
a handover-related information, e.g., a handover configuration like a preferred set of gNBs, or a CHO configuration.

In accordance with embodiments, the UE is to transmit the IuC information on one or some or all CCs used by the UE.

In accordance with embodiments, the IuC information relates
only on the CCs on which the IuC information is transmitted, or
on one or more or all of the CCs where the UE has a future transmission.

In accordance with embodiments,
the UE is to obtain selected resources for a transmission by performing a resource selection based on a channel busy ratio, CBR, the resource selection comprising:
   selecting resources for the SL transmission which are above a pre-defined or configured CBR-threshold, or
   removing resources for the SL transmission which are below a pre-defined or configured CBR-threshold, and
responsive to receiving the IuC information, the UE is to
   remove the received unavailable or not preferred resources from the selected resources, e.g., based on the non-preferred set of resources or based on the CI, or
   add some or all of the received available or preferred resources to the selected resources.

The present invention provides a method for operating a user device, UE, for a wireless communication network, wherein the UE is to communicate with one or more further UEs in the wireless communication network over a sidelink, SL, and wherein the UE is configured or preconfigured to support sidelink carrier aggregation, SL-CA, the SL-CA comprising a plurality of component carriers, CCs, the method comprising:
selecting, by the UE, the CCs for the SL communication
   in accordance with a configuration or pre-configuration of the SL-CA, and/or
   based on inter-UE coordination, IuC, information indicating available/preferred or unavailable/not-preferred resources or a collision, e.g., collision indicator, CI.

### Second Aspect

In accordance with a second aspect of the present invention, a UE which supports SL-CA selects its CCs for transmitting to or receiving from a further UE such that the UE and the further UE use the same CC combination or a CC combination that includes at least all carriers that are used by the further UE.

In accordance with the second aspect, drawbacks in conventional approaches are addressed which arise from the fact that UEs performing a sidelink communication basically support SL-CA, however, among the available CCs, the respective UEs may select different CCs for a SL communication using carrier aggregation so that there may be a mismatch among the used CCs. In accordance with embodiments of the second aspect of the present invention, the UE may perform an appropriate carrier switching so as to select the CCs for transmitting to or receiving from the further UE, namely in such a way that the UE uses resources also used by the further UE thereby avoiding that the further UE does not receive transmissions on a certain carrier thereby improving the overall SL communication when applying SL-CA.

The present invention provides a user device, UE, for a wireless communication network,
wherein the UE is to communicate with one or more further UEs in the wireless communication network over a sidelink, SL,
wherein the UE is configured or preconfigured to support sidelink carrier aggregation, SL-CA, the SL-CA comprising a plurality of component carriers, CCs, and
wherein the UE is to select one or more or all of the CCs for transmitting to or receiving from a further UE such that the UE and the further UE use the same CC combination or a CC combination that includes at least one or more carriers that are used by the further UE.

In accordance with embodiments, the UE is to perform carrier switching so as to select the CCs for transmitting to or receiving from the further UE.

In accordance with embodiments, responsive to a certain event, the UE is to automatically switch back from using the selected CCs to
a certain CC configuration, e.g., a previously used CC configuration prior to performing SL CA, or to a configured or pre-configured default CC configuration, e.g., the default CC configuration can be that the UE is configured with carrier aggregation using a certain band combination, e.g., two neighboring CCs in the ITS band, or the default configuration could be that the UE does not use CA at all, but rather a single CC with a specified center frequency and bandwidth,
a single CC, e.g., without using SL CA,
a different bandwidth part, BWP, e.g., having a different center frequency, bandwidth and/or numerology,
a different mode, e.g., from SL Mode 2 to SL Mode 1, or vice versa.

In accordance with embodiments, the certain event comprises one or more of the following:
a completion of the SL communication with the further UE using the selected CCs, e.g., a transmission to and/or a reception from the further UE is completed, e.g., a reception or a transmission of a feedback message, e.g., a HARQ-ACK or a HARQ-NACK, from/to the further UE,
the number of decoding errors on data transmitted on the selected CCs exceeds a predefined threshold, e.g., too many HARQ-NACKs received,
a duration of not transmitting and/or receiving on the selected CCs exceeds a configured or pre-configured threshold, e.g. a timeout while waiting for a HARQ feedback,
a CBR on one, some, or all of the selected CCs is above a configured or pre-configured threshold,
the number of LBT-failures exceeds a (pre-)configured threshold,
power saving purposes: e.g., the power budget exceeds a (pre-)configured threshold, and/or the UE needs to perform DRX,
emergency situation, e.g., the UE receives an emergency indicator, e.g., emergency code.

In accordance with embodiments, the UE is to indicate one or more of the following in a message to a further UE:
one or more time windows when the UE is receiving on a certain CC,
a conflict indication when the UE is not receiving due to a switching gap or a reception on a different CC,
a default CC that the UE is receiving unless the UE is switching to receive on a different CC,
one or more DRX patterns/configuration for the selected CCs.

In accordance with embodiments, the UE is to coordinate the selected CCs for transmitting to or receiving from the further UE via one or more of
a specification of the wireless communication network, or
a resource pool configuration,
a handover or conditional handover, CHO, configuration exchange,
a signaling using, e.g., PC5 RRC, MAC CEs or SCIs, or
Uu signaling via a RAN entity, like a gNB, when operating in SL Mode 1, e.g., using UCI.

In accordance with embodiments,
the UE is to perform a resource selection based on a channel busy ratio, CBR, and select resources for the SL transmission which are above a pre-defined or configured CBR-threshold, and
the UE is to restrict the resource selection to resources of the CCs used by the UE and by the further UE for the SL communication.

In accordance with embodiments, the UE is not to select resources from a certain CC if the set of resources available on the certain CC, e.g., based on the CBR-threshold, is below a configured or pre-configured threshold.

In accordance with embodiments, the UE is to perform a transmission in a time domain without aggregating a further CC in case a number of available resources on the further CC is too small.

In accordance with embodiments, the UE is to restrict the resource selection in case of one or more of the following:
a feedback is expected, e.g., a HARQ-feedback,
beam management control traffic is expected, e.g., a beam failure recovery (BFR) indication,
a reception of control and/or data and/or feedback and/or synchronization signals from another UE is expected, e.g., which was previously indicated via PSCCH TRIV/FRIV-signaling,
a channel access procedure, CAP, for a high priority transmission is expected, e.g., in case of SL in unlicensed bands, SL-U, a certain CC in carrier aggregation is restricted to only allow certain CAPs or not to allow performing certain CAPs,
the UE is already performing a transmission on another CC, e.g., a neighboring CC or a CC with a certain distance or offset to a carrier frequency to the CC,
an upcoming transmission, e.g., a data transmission, a control transmission, a feedback transmission, e.g., PSFCH HARQ-ACK/NACK or HARQ-NACK-only, an IuC/AIM transmission, e.g., preferred or non-preferred set of resources or collision indicator (CI), a transmission of a synchronization signal, e.g., S-SSB, or a transmission of a beam management or beam maintenance control signal.

In accordance with embodiments, the UE is to restrict the resource selection by
excluding the resources of the CCs from the resource selection, or
applying to the resources of the CCs a penalty factor or penalty threshold avoiding selection of these resource or preferring selection of these resources.

In accordance with embodiments, the UE is to apply different penalty factors or thresholds depending on one or more of:
a priority of a transmission,
a QoS-requirement, e.g., if data with ultra-low delay requirements is to be send, the data might be preferred to be send over a larger frequency bandwidth, which might only be possible doing carrier aggregation,
a cast-type,
a type of transmission, e.g., data/control/feedback/synchronization etc.,
other transmissions, e.g., transmissions in neighboring bands, which may cause interference on a certain CC.

The present invention provides a method for operating a user device, UE, for a wireless communication network, wherein the UE is to communicate with one or more further UEs in the wireless communication network over a sidelink, SL, and wherein the UE is configured or preconfigured to support sidelink carrier aggregation, SL-CA, the SL-CA comprising a plurality of component carriers, CCs, the method comprising:
selecting, by the UE, one or more or all of the CCs for transmitting to or receiving from a further UE such that the UE and the further UE use the same CC combination or a CC combination that includes at least one or more carriers that are used by the further UE.

### Third Aspect

In accordance with a third aspect of the present invention, the UE which supports SL-CA and selects a certain number of CCs for transmitting to or receiving from a further UE is enabled to skip one or more resources out of a periodic transmission in order to transmit a certain transmission, like a high priority transmission, on one of the selected CCs.

In other words, in accordance with the third aspect of the present invention, a pre-emption is allowed when implementing SL-CA thereby improving the overall communication capabilities of the UE by allowing certain transmissions, like a high priority transmission, to be performed using any one of the available CCs.

The present invention provides a user device, UE, for a wireless communication network,
wherein the UE is to communicate with one or more further UEs in the wireless communication network over a sidelink, SL,
wherein the UE is configured or preconfigured to support sidelink carrier aggregation, SL-CA, the SL-CA comprising a plurality of component carriers, CCs,
wherein the UE is to select one or more or all of the CCs for transmitting to or receiving from a further UE, and
wherein the UE is to skip one or more resources out of a periodic transmission in order to transmit and/or receive a certain transmission on another CC or on the same CC or on aggregated CCs.

In accordance with embodiments, the certain transmission is a transmission on one or more of
a sidelink CC,
a Uu CC, e.g., an uplink transmission,
a transmission in an unlicensed band, e.g., a WiFi transmission.

In accordance with embodiments, the certain transmission has one or more of
a priority exceeding a certain threshold, e.g., an absolute threshold or a threshold relative to the priority of the periodic transmission,
higher QoS, e.g., with respect to the latency requirement and/or data volume and or service class, e.g., small data, guaranteed bit-rate (GBR) or delay critical GBR, as defined by the 5G QoS (5QI) table.

In accordance with embodiments, the certain transmission comprises one of the following:
a data signal,
a control signal,
a feedback signal,
a synchronization signal,
beam management-related information,
a measurement signal, e.g., a signal containing channel state information, CSI, or channel quality related information,
a wake-up signal (WUS),
a positioning reference sequence, e.g., using positioning reference signals (PRS).

The present invention provides a method for operating a user device, UE, for a wireless communication network, wherein the UE is to communicate with one or more further UEs in the wireless communication network over a sidelink, SL, and
wherein the UE is configured or preconfigured to support sidelink carrier aggregation, SL-CA, the SL-CA comprising a plurality of component carriers, CCs, the method comprising:
   selecting, by the UE, one or more or all of the CCs for transmitting to or receiving from a further UE, and
   skipping, by the UE, one or more resources out of a periodic transmission in order to transmit and/or receive a certain transmission on another CC or on the same CC or on aggregated CCs.

### Fourth Aspect

In accordance with a fourth aspect of the present invention, a UE supporting SL-CA and selecting a certain number of CCs for transmitting to a further UE implements data duplication by sending a data packet over a first of the CCs and an exact copy or additional redundancy for the data packet over a further CC thereby improving the reliability of the data transmission towards the further UE.

The present invention provides a user device, UE, for a wireless communication network,
wherein the UE is to communicate with one or more further UEs in the wireless communication network over a sidelink, SL,
wherein the UE is configured or preconfigured to support sidelink carrier aggregation, SL-CA, the SL-CA comprising a plurality of component carriers, CCs,
wherein the UE is to select one or more or all of the CCs for transmitting to or receiving from a further UE, and
wherein the UE is to perform data duplication by sending a data packet over a first CC and an exact copy or an additional redundancy version of the data packet over a second CC, the first and second CCs being different.

In accordance with embodiments, the UE is to perform data duplication responsive to the UE and/or the data packet meeting one or more criteria.

In accordance with embodiments, the criteria comprise one or more of the following:
a priority or a QoS parameter, e.g., a 5QI value, of the data packet exceeds a certain threshold,
in case the UE is not sure whether the further UE listens on a particular CC,
the data packet is to be transmitted according to a certain cast-type, e.g., data duplication, may be performed as default for broadcast and/or groupcast and/or unicast transmissions,
a quality on the second CC is above or below a pre-defined threshold, e.g., based on CBR or based on the interference, e.g., SINR,
a sufficient number of CCs is available,
inter-UE coordination, IuC, or assistance information messages, AIMs, are available for a certain CC,
in case LBT failures exceed a number of configured or pre-configured number, e.g., in case the UE is operating on an unlicensed carrier as in sidelink unlicensed (SL-U),
depending on its battery state, e.g., in case the UE has low battery, the said UE might want to perform data duplication to increase the probability of a successful transmission and to avoid retransmissions, to go into an DRX mode as fast as possible,
the UE being triggered to perform duplication by another device, e.g., by another SL UE, e.g., by a control message, e.g., IuC.

The present invention provides a method for operating a user device, UE, for a wireless communication network, wherein the UE is to communicate with one or more further UEs in the wireless communication network over a sidelink, SL, and wherein the UE is configured or preconfigured to support sidelink carrier aggregation, SL-CA, the SL-CA comprising a plurality of component carriers, CCs, the method comprising:
selecting, by the UE, one or more or all of the CCs for transmitting to or receiving from a further UE, and
performing, by the UE, data duplication by sending a data packet over a first CC and an exact copy or an additional redundancy version of the data packet over a second CC, the first and second CCs being different.

### First, Second, Third and Fourth Aspects

In accordance with embodiments, the UE is operated in an out-of-coverage mode in which the UE
is not connected to a base station of the wireless communication system, e.g., the UE operates in Mode 2 or is not in an RRC connected state, so that the UE does not receive from the base station a sidelink resource allocation configuration or assistance, and/or
is connected to a base station of the wireless communication system, which, for one or more reasons, is not capable to provide a sidelink resource allocation configuration or assistance for the UE, and/or
is connected to a base station of the wireless communication system not supporting a sidelink service, like a NR V2X service, e.g., a GSM, UMTS or LTE base station or WiFi AP.

In accordance with embodiments, the UE comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, or a mobile terminal, or a stationary terminal, or a cellular IoT-UE, or a SL UE, or a vehicular UE, or a vehicular group leader UE, GL-UE, or a scheduling UE, S-UE, or an IoT or narrowband IoT, NB-IoT, device, or a ground based vehicle, or an aerial vehicle, or a drone, or a moving base station, or road side unit, RSU, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or a Wi-Fi device, station (STA), access point (AP), node or mesh node, or mesh point, or Mesh AP, or any sidelink capable network entity.

The present invention provides a wireless communication system, like a 3^{rd} Generation Partnership Project, 3GPP, system, comprising one or more of the inventive user devices, UEs, and/or one or more base stations.

In accordance with embodiments, the BS comprises one or more of a macro cell base station, or a small cell base station, or a central unit of a base station, or a distributed unit of a base station, or an Integrated Access and Backhaul, IAB, node, or a relay node, or a smart repeater, or a road side unit, RSU, or a WiFi access point, AP, or a UE, or a SL UE, or a group leader UE, GL-UE, or a relay or a remote radio head, or an AMF, or an SMF, or a core network entity, or mobile edge computing, MEC, entity, or a network slice as in the NR or 5G core context, or any transmission/reception point, TRP, enabling an item or a device to communicate using the wireless communication network, the item or device being provided with network connectivity to communicate using the wireless communication network.

The present invention provides a computer program product comprising instructions which, when the program is executed by a computer, causes the computer to carry out one or more methods in accordance with the present invention.

Embodiments of the inventive aspect are now described in more detail with reference to the accompanying drawing. It is noted that the subsequently outlined and described aspects or embodiments may be combined such that some or all of the aspects/embodiments are implemented within one embodiment. Further, it is noted that when referring to “resources”, in this description, a resource is to be understood as comprising one or more of the following:
one or more symbols, e.g., OFDM symbols,
one or more time slots or subframes or frames or transmission time intervals, TTI,
one or more frequencies or carriers or channels or subchannels or group of subchannels,
one or more interlaces,
one or more frequency bands, like unlicensed subbands,
one or more bandwidth parts,
one or more resource pools,
one or more LBT sub-bands,
one or more spatial resources, e.g., using spatial multiplexing, precoding and/or beamforming.

Furthermore, it is noted that when referring to “a set of resources”, in this description, a set of resources may contain one or more than one resource, with the definition of a resource as mentioned above. Moreover, it is noted that when referring to a “channel”, in this description, this may refer to a set of the resources as mentioned above. Thus, a “channel” may also refer to a single carrier, a sub-channel, a sub-band, a resource pool or a SL BWP.

### First Aspect

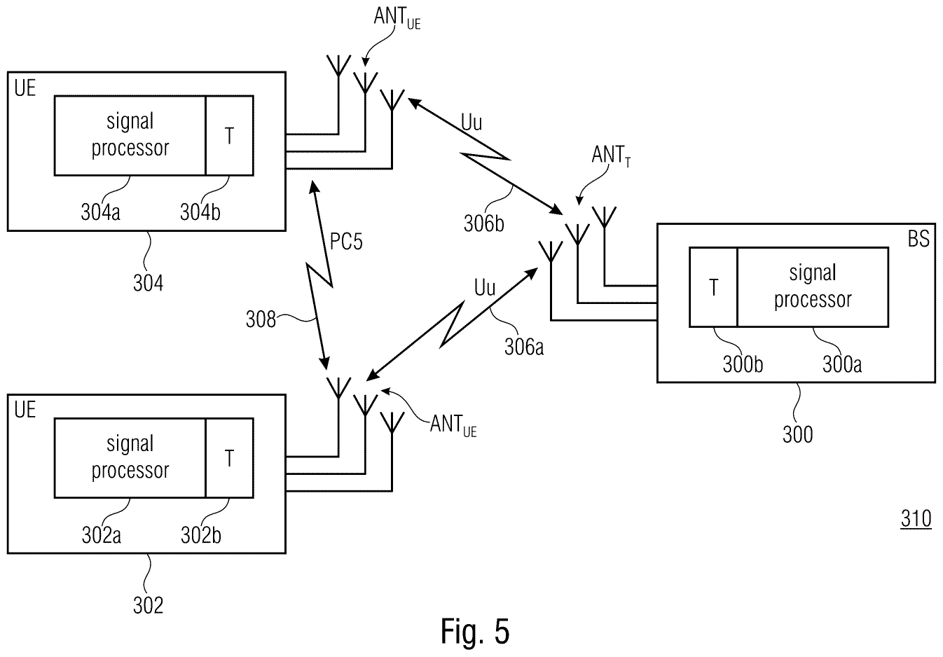

Embodiments of the first aspect of the present invention are described. FIG. 6 illustrates a user device, UE, 400 according to an embodiment of the first aspect of the present invention. UE 400 is operating in a wireless communication network, like the wireless communication network illustrated above with reference to FIG. 1 or to FIG. 2. UE 400 communicates with one or more further UEs 400-1 to 400-n over a sidelink, as is illustrated schematically by the PC5 connections. As is schematically illustrated at 402, UE 400 supports sidelink carrier aggregation, SL-CA, which comprises a plurality of component carriers, CCs. UE 400 selects one or more or all of the CCs for transmitting to or receiving from a further UE, like UE 400-1. UE 400, as is schematically illustrated at 404, selects the CCs for the sidelink communication over the PC5 connections with the respective further UEs 400-1 to 400-n in accordance with a SL-CA configuration with which the UE 400 is configured or pre-configured. In addition or alternatively, UE 400 selects the CCs based on inter-UE coordination, IuC, information which indicates available/preferred or unavailable/non-preferred resources or which indicates a collision, for example by means of a collision indicator, CI, on certain resources.

UE 400 is advantageous over conventional UEs as it allows for a more efficient SL communication when applying SL-CA because by selecting the CCs on the basis of the configuration or pre-configuration of the SL-CA appropriate CCs may be selected that, for example, are suited for performing a desired SL communication in certain situations or under certain circumstances.

In accordance with embodiments, the SL-CA configuration may indicate one or more properties of a given CC. For example, the one or more properties of a given CC may include one or more of:
a center frequency of a given CC,
a bandwidth of a given CC,
a bandwidth part, BWP, to be used on a given CC,
a bandwidth class of a given CC, e.g., a class defined by the aggregated transmission bandwidth configuration and a maximum number of component carriers supported by a UE,
a fallback group, which is a group of carrier aggregation bandwidth classes for which it is mandatory for a UE to be able to fallback to a lower order CA bandwidth class configuration,
a numerology for a given CC,
a resource pool configuration for a given CC.

Thus, UE 400 may select one or more CCs for a certain transmission to be performed in such a way that, for example, a suitable center frequency is provided. A UE may select a carrier in a lower frequency band, in case it needs to overcome a higher pathloss, as to reach other UEs which are located further away from the said UE or which are obstructed by objects or shielded by material which causes high penetration loss to radio signals, e.g., metallic-shielded windows. On a contrary, a UE may select a higher frequency band, if the corresponding UE is located closer to the said UE, and/or in case the said UE wants to reduce interference to other radio devices, e.g., UEs or BSs or WiFi devices, which are not required to decode the signals transmitted by the said UE. Furthermore, the UE may select one or more CCs in such a way, that a sufficient bandwidth is provided for the transmission. Also, certain transmissions may be transmitted using a certain numerology, so that a CC having a suitable numerology may be selected on the basis of the SL-CA configuration. Also, different CCs may have different resource pool, RP, configurations so that, for example, one resources pool may provide for more suitable resources for a transmission than another resource pool so that the UE may select a CC having a suitable TX-RP configuration to be used for a certain transmission. A certain transmission may require a certain center frequency, since it may need to overcome a specific path loss, e.g., in case the receiving UE of the data transmission is located within a certain distance away from the transmitting UE. Furthermore, a certain component carrier may only support a certain bandwidth, which may not provide enough data rate for a certain transmission, such that the UE may decide to use a different CC by performing carrier switching and/or perform carrier aggregation, in order provide the required QoS, e.g., fulfilling a 5QI value, for a particular transmission.

In accordance with other embodiments the one or more properties of a given CC may include a cast-type be used on the given CC, for example a CC may be used for a broadcast, a multicast, groupcast or a unicast only. Restricting a CC to a certain or preferred cast-type is advantageous as it allows a separation of the respective cast-type transmissions or communications among different CCs so that for UEs, which are interested in a particular cast-type, for example when transmitting security-related broadcast messages, need to perform receptions, e.g., blind decodings, only on a particular component carrier. Thus, rather than blind decoding the entire available carriers, for a certain cast-type information, the UE may restrict its blind decoding efforts to a certain component carrier thereby reducing, for example, power consumption. Furthermore, this technique increases the reliability since the UE does not have to search on multiple carriers to receive certain messages. In other words, if the wireless communication network supports unicast, groupcast, multicast and broadcast communications, confining certain CCs to be used for a certain cast-type is beneficial due to the UE being capable to restrict its decoding to the respective CC, thereby saving power.

In accordance with other embodiments the one or more properties of a given CC may include a service so that, in a similar way as described above with regard to the cast-type, UEs, which for example, primarily perform transmissions associated with a certain service type may limit the transmission/reception of such transmissions to one or more CCs associated with a certain service type. Thus, blind decodings for such transmissions are again limited to the CC thereby saving power.

On the other hand, transmissions may be made only in one or more CCs thereby allowing the UE to use its full transmit power when transmitting transmission of a certain service type only onto the selected CCs associated with the service type. A service type may be any of the resource types defined within the 5G QoS framework, 5QI, with the resource types guaranteed flow bit rate, GBR, non-GBR, or delay critical GBR. Note, a 5QI value may be defined with a corresponding default priority level, a packet delay budget, PDB, a target packet error rate, PER, a default maximum data burst volume, and/or a default averaging window. In accordance with embodiments, the service type may define that certain messages, like basic safety messages, e.g. BSM, are only allowed on a particular component carrier while other messages, like multimedia messages are provided on a different carrier. In accordance with other embodiments, the service type may decide between an NR transmission and a legacy transmission so that, for example, legacy transmissions/receptions are only provided on one or more particular component carriers providing the advantage of a compatibility of an NR UE with a legacy UE allowing the NR UE to transmit/receive legacy transmission to/from a legacy UE.

In accordance with other embodiments the one or more properties of a given CC may include a transmission priority to be used on the given CC. One or more CCs may be associated with transmissions having different priorities. For example, for a certain transmission, a preferred component carrier may be determined on the basis of the transmission priorities associated with the respective CCs defined by the SL-CA configuration. A preference list may be provided via an SL-CA configuration or an associated RP configuration. The preference list may be based on a simple ranking indicating, for example, a CC to be used for transmissions with the highest priority, a further CC to be used for transmissions having a medium priority and a third CC to be used for transmissions having a low priority. According to embodiments, the list may include a primary CC to be used for high priority transmissions and a number of secondary CCs to be used for transmissions having lower priorities, for example a single secondary CC may be used for transmissions not being high priority transmissions or, in accordance with other embodiments, a plurality of secondary CCs may be employed for transmitting transmissions with decreasing levels of priority. The ordering of the CCs may be used to modify the blind decoding behavior, the transmission and/or reception prioritization, and/or the reception of reference signals, e.g., synchronization signals. This means, the UE may first perform blind decoding on the k-highest priority carriers, where k is a natural number. In another embodiment, the UE may have simultaneous receptions and transmissions on different carriers. To decide on which carrier to transmit and/or to receive or whether to transmit or receive on all carriers, the UE may use the ordering of the carriers. For example, the UE may choose the highest-ranking carrier for which it has to perform a reception and/or transmission, and then applies an intra-carrier prioritization rule according to a specification of the wireless communication network, like the NR specifications, i.e., the UEs are pre-configured accordingly. In yet a further embodiment, the UE may expect certain reference signals, for example, synchronization signals, only on the k-highest ranking carriers, where k is a natural number.

In accordance with other embodiments the one or more properties of a given CC may include whether feedback is enabled on the given CC, e.g., whether feedback which is sent responsive to a transmission from the further UE 400-1 to UE 400 is confined to a certain component carrier. The advantage of such an approach is that when confining feedback to a certain CC, the UE 400 only has to perform blind decoding with regard to the feedback in this part of the spectrum, i.e., only on a certain CC. Thus, in accordance with embodiments, the SL-CA indicates for a certain CC or for some or more of the CCs whether feedback is enabled thereon or not. For example, indicating that a feedback is enabled on a given CC may comprise an indication whether a feedback channel, like a PSFCH, is present on the given CC. In accordance with another embodiment, when there is no feedback enabled on a certain CC, the SL-CA configuration may indicate which of the CCs among the plurality of CCs may be used for the feedback. In other words, when the UE 400 transmits towards UE 400-1 on a first component carrier CC1, it may be that CC1 does not allow for a feedback transmission from UE-1 back to UE 400, however, the SL-CA configuration indicates that another one of the CCs for example CC2 or CC3 (see FIG. 3 and FIG. 4), may be used for transmitting the feedback or may have implemented the PSFCH. The advantage of this approach is that even in a situation in which a given CC does not allow for a feedback transmission, both the receiving UE and the transmitting UE know the CC on which the feedback is to be provided so that it is may be transmitted by the receiving UE only on the indicated CC using, for example, its full transmit power so that it is securely transmitted while the transmitting UE needs to monitor only a small part of the spectrum for the feedback thereby reducing the power consumption.

In accordance with other embodiments the one or more properties of a given CC may include that among the plurality of CCs one or more CCs are legacy CCs, that are monitored by legacy UEs.

In accordance with other embodiments the one or more properties of a given CC may include one or more of the following:
a UE type to be used on a given CC, e.g., any of V2X-UE, IoT-UE, RSU, relay node,
an NR release type to be usable/allowed for a given CC, e.g., NR Release 17 V2X feature allowed and/or NR Release 18 features allowed, or whether this CC is only used for a certain 3GPP release type, e.g., Rel-16, in order to ensure backwards compatibility,
whether a UE can perform power saving, e.g., DRX or eDRX on the given CC or not, as well as a possible DRX configuration for the given CC,
whether IuC is enabled or disabled on the given CC,
whether the transmission and/or reception of wake-up signals (WUS) is enabled/disabled on the given CC,
whether positioning reference signals, e.g., PRS, can be transmitted on a given CC.

In accordance with further embodiments, the SL-CA configuration may indicate that among the plurality of CCs one or more CCs contain a predefined signal or predefined information.

In accordance with other embodiments the predefined signal includes one or more of the following:
a data signal,
a control signal,
a feedback signal,
one or more synchronization signals, e.g., one or more synchronization signals provided to the UE, such as a sidelink primary synchronization signal, S-PSS, and/or a sidelink secondary synchronization signal, S-SSS and/or any other type of m-sequence and/or Gold-sequence used for synchronization purposes, certain synchronization preambles for a re-synchronization, e.g., to be used in case the UE requires re-synchronization. For example, if a UE has an issue regarding time and/or frequency synchronization, such as a large carrier frequency offset, CFO, and has to re-sync using a preferred CC, only certain synchronization preambles, i.e., SSBs, may be transmitted on a given CC,
a broadcast signal, e.g., transmitted via the physical sidelink broadcast channel, PSBCH,
a positioning reference signal, PRS, with the support of different positioning methods such as time difference of arrival, TDOA, angle-of-departure, AoD, multi-round trip time, multi-RTT,
a wake-up signal, WUS, typically used for reduced capability devices, RedCap, to wake up device which are in power saving mode, e.g., discontinuous reception, DRX or enhanced-DRX,
a narrowband signal, e.g., a NB-IoT signal,
a signal containing beam management-related information,
a measurement signal, e.g., a signal containing channel state information, CSI, or channel quality related information.

In accordance with other embodiments the predefined information include an interference threshold for a given CC. The SL-CA configuration may indicate the CBR threshold or a non-empty set of CBR thresholds valid for one, some or all of the CCs. The CBR threshold may be employed for determining within a CC which of the resources R are to be used for a communication. As has been illustrated above in FIG. 3 and FIG. 4, within a certain CC, only some of the resources R may be used for the communication, namely those which exceed the CBR threshold, while other resources (the ones not illustrated in FIG. 3 and FIG. 4), which are below the CBR threshold, are not used for the communication. In other words, CCs may be restricted to be used if a CBR or interference indicator is below a configured or pre-configured threshold. For example, UE 400 may prefer a highest-ranking carrier with a CBR/interference indicator below a certain threshold for a new transmission. In accordance with embodiments, the interference may be defined in terms of the Signal to Interference plus Noise Ratio, SINR, or interference power, or by means of interference caused by neighboring bands, e.g., the Adjacent Channel Leakage power Ratio, ACLR, or spurious emissions, or in terms of interference cause by non-3GPP systems operating in the same or in a neighboring band. Due to bad filtering at the UE with regard to neighboring CCs, the UE may not be able to receive/decode in a given carrier while another UE or STA, for example a WiFi modem, is transmitting in such a neighboring band.

In accordance with embodiments, UE 400 may comprise of an array antenna including a plurality of array elements or it may include a plurality of antenna elements so as to allow beamforming. Also, one or more of the further UEs 400-1 to 400-n may have such a functionality. In such scenarios, beam management procedures may be required which include finding beam pair links, BPL, so as to:
point a transmit beam into a certain direction,
point a receive beam into a certain direction,
align both transmit and receive beams.

Beam management is preferably implemented for a communication in the high frequency range, e.g., in FR2, where the radiation of beams is limited due to the high carrier frequency, and it is desired to extend the reach by utilizing beamforming techniques. Beamforming may further involve maintaining beams, e.g., by performing beam-steering while one or both of the user devices involved in beamforming are moving, as well as recovery procedures, in case the beams are misaligned. The beam misalignment may happen in case one or both of the involved communication partners change their position or switch to a different antenna panel, for example in case of a multi-TRP device. This may happen in case certain antennas are obstructed. In case of such an obstruction, beam alignment may not be possible, which may even result in a radio link failure, RLF. To an RLF or to overcome an RLF, beam management may step in and perform one or more of
a beam failure detection (BFD),
a beam failure recovery (BFR).
   These procedures may involve transmission and/or reception of a BFR request (BFRQ) and/or BFR response BFRR, which include information on the resources, the transmit and/or receive beams, the timings, and the like.

In accordance with other embodiments, when implementing beam management, the predefined information may include the beam management information, beam maintenance information or beam recovery related information. In some cases, it may be required to transmit beam management information on every CC or on the CC on which the UE transmits or receives on using beam forming, so as to successfully establish the beam-pair link, BPL, on a particular carrier. In other cases, it may only be required to transmit BFD or BFR on certain CCs, e.g., on a carrier, that a UE may still decode, which is not suffering under RLF, e.g., like a fail-safe carrier, FS-CC. This may be a carrier with a lower center frequency, such that the likelihood of successful reception is maximized, and such that a UE may perform certain failure recovery procedures, e.g., switch over from V2X Mode 2 to Mode 1 or vice versa, or handover to a gNB via Uu. In other words, the beam management or beam maintenance information may include information on the beam-pairing and/or the beam failure recovery, BFR, and/or the beam failure detection, BFD.

In accordance with other embodiments, the predefined information may include
control information on a particular CC used for Uu, e.g., containing information in case the UE wants to switch from a Mode 2 operation to a Mode 1 operation or vice versa, or in case the UE wants to switch from SL to Uu or to a connection using a relay node, e.g., a Relay UE,
information related to a handover or to a conditional handover, CHO,
paging-related information,
discovery-related information,
broadcast-related information, e.g., a broadcast control channel,
IuC-related information, e.g., AIMs. The benefit of providing AIMs on a subset of carriers is that AIMs may be send on very robust carriers, e.g., lower frequency, such as on a configured or pre-configure FS-CC, such that AIMs are transmitted very robust increasing the likelihood for successful decoding at a UE. This may then trigger the UE to perform certain fail-safe mechanisms, such as changing its V2X mode, e.g., switch from Mode 2 to Mode 1 or vice versa, or perform a HO to a gNB.

In accordance with embodiments, the configuration or pre-configuration of the SL-CA may indicate among the plurality of CCs a proper subset of CCs containing the predefined signal or the predefined information, i.e., one or some but not all CCs contain a predefined signal or predefined information. An advantage of this embodiment is that a UE expecting to receive a certain signal or certain information is aware on which of the CCs the transmission takes place so that the reception, e.g., the blind decoding may be limited only to one or more CCs but it is not necessary to monitor the entire bandwidth provided by the SL-CA approach thereby allowing a more efficient processing, i.e., less blind decoding efforts, at the UE, thereby saving power. In accordance with embodiments, when assuming that SL-CA configured N CCs, N being a natural number, the predefined signal or predefined information may be contained in only one of the N CCs, or in two of the N CCs, or even in up to n-1 of the N CCs.

In accordance with further embodiments, the SL-CA configuration may indicate one or more CCs to used in a predefined scenario. When the configuration or pre-configuration of the SL-CA indicates one or more CCs to be used in a predefined scenario, one or more of the following may be indicated:
CCs to be used dependent on a position of the UE, e.g., based on the geolocation of the UE in 2D or 3D space, or based on the minimum required communication range (MCR), e.g., the distance between a UE and a corresponding transmitter or receiver UE,
CCs to be used dependent on the mobility state of the UE,
one or more CCs to be used in case the UE or a further UE with which the UE is to communicate over the SL is not able to transmit or receive on a certain CC,
one or more CCs to be used in case of a unicast link establishment by the UE.

In accordance with embodiments, dependent on a position of the UE one, some or all CCs may be associated with a certain position. This approach is advantageous as for certain positions of the UE not all of the CCs may allow for a transmission/reception or, more generally, for a SL communication with the further UE in a way that satisfies predefined or desired properties of the communication. Thus, associating a CC with a certain position of the UE allows for a more reliable and effective SL communication as possible problems, like radio link failure, e.g., due to high path loss on a high frequency band, or interference on particular carriers, e.g., due to high SINR and/or ACLR and/or spurious emissions from certain neighboring carriers, may be avoided.

In accordance with embodiments, the CCs is to be used dependent on the position of the UE may be CCs that are to be used dependent on a distance between the UE and a further UE with which the UE communicates over the sidelink, like a distance between the UE 400 and the further UE 400-1 in FIG. 6. For example based on a minimum required communication range, MCR, the CCs may be classified so that one or more CCs are to be used when being within the MCR, while other CCs may be more suited when communicating with a further UE which is outside the MCR.

Note, the location may be based on a 2D location or also based on a 3D location, in case the UE is a UAV, e.g., a drone, and is communicating via SL to further UEs.

In accordance with other embodiments, certain CCs may be associated with a certain geolocation or zone. For example, on the basis of a zone index or an area identifier, e.g., the tracking area identifier TAI, an associated CC may be selected which provides for a SL communication within desired limits or fulfilling desired properties. Thus, an improvement in the SL communication may be achieved by avoiding CCs which have been determined to be not suitable for a communication at a certain geolocation or within a certain zone.

In accordance with other embodiments, rather than relying on a geolocation or zone, CCs may be used dependent on the location of the UE in the wireless communication network like an absolute location in Cartesian coordinates or a relative location to a certain reference point. For example, in certain areas on the world certain CCs may operate in frequency ranges which are not admissible so that, for such locations, the UE is aware that no SL communication is to be carried out on a certain CC. Stated differently, for a certain location among the plurality of CCs the UE is informed about those which may be used, for example in accordance with regulations. Thus, undesired or unlawful transmissions on non-allowed CCs are avoided.

In accordance with other embodiments, certain CCs may be associated with the mobility state of the UE, e.g., with is one or more of the following:
a velocity of the UE,
a mode 1 connectivity of the UE, e.g., connected to a certain gNB,
mode 2 connectivity of the UE,
a height of the UE or a 2D or 3D trajectory of the UE, e.g., in case the UE is a drone,
a type of track, e.g., a UE moving on the Autobahn or on a dirt road, railroad track, water road,
a transition state, e.g., the UE performing a handover, e.g., HO or CHO, between gNBs, e.g., for UEs having a connectivity to eNB or gNB.

In accordance with yet further embodiments, the SL-CA configuration may indicate the CCs to be used in case UE 400 or the further UE 400-1 in FIG. 6 with which the UE 400 communicates over the SL is not able to transmit or receive on a certain CC. For example, a transmission/reception on a certain CC may not be possible due to an ongoing transmission on another CC or due to ongoing transmissions on neighboring bands which may cause an interference on the CC, for example, due to a leakage of power or spurious emission. Also, transmissions by another technology within the same CC or in a neighboring CC, may cause a situation in which UE 400 and/or the further UE 401 are not able to operate on a certain CC. Such transmissions may include, for example, transmissions by a WiFi system or an IEEE-based V2X transmissions using IEEE 802.11p- or802.11 bd-based or similar technologies. This embodiment is advantageous as it avoids that for a communication between UE 400 and UE 400-1 only those CCs are used on which a transmission/reception is possible thereby avoiding a loss of transmissions on CCs due to ongoing transmissions on the same CC or on neighboring bands.

In accordance with yet further embodiments, the SL-CA configuration may indicate one or more CCs to be used in case of a unicast link establishment by the UE 400. For example, while UE 400 may be capable of performing a broadcast to all further UEs 400-1 to 400-n or to a subset thereof, which is then referred to as a groupcast or as a multicast, UE 400 may also establish a unicast link between UE 400 and UE 400-1, i.e., only a link from UE 400 to a single one of the further UEs. In a situation in which the UE wishes to perform a unicast transmission to a single one of the further UEs, the UE 400 may inform the further UE about the one or more CCs it uses for the unicast link so that the further UE may adapt accordingly. For example, the UE 400 may only send possible CCs for the receptions, so that further UE may adapt its transmission such that they are carried out on the mentioned CCs for the reception. This may be beneficial in case the transmitting UE 400 may be constrained in the selection of CCs due to interference, ACLR or spurious emissions by other UEs, or in case it wants to benefit from a beamforming gain, which may only be possible in a certain frequency band, on the said CC, since the beamforming gain may depend on the specified carrier frequency. If operating on an unlicensed carrier, e.g., in SL-U, this may be beneficial since the UE 400 may choose a carrier which is less used by other technologies, e.g., IEEE-based technologies such as Bluetooth or WiFi, which the other UEs may not be aware of, since it may not have knowledge on the medium usage of non-3GPP technologies on a given frequency band.

As is described above with reference to FIG. 6, besides selecting the CCs in accordance with the SL-CA configuration, in addition or alternatively, in accordance with the first aspect of the present invention, the CCs may be selected based on an inter-UE coordination, IuC, information indicating available/preferred or unavailable/not-preferred resources or indicating a collision, for example by means of a collision indicator, CI. UE 400 may perform a resource selection, for example when operating in an NR Mode 2. The resource selection may be performed based on the CBR. In case a UE calculates that a certain number of resources are above a pre-defined or configured CBR-threshold, it selects such resources for a transmission. In accordance with embodiments, in case the UE receives IuC information prior to the selecting the resources, it may remove resources from its resource selection which are indicated by the IuC information to be not available/not preferred, provided that following the removal, there are still enough resources available for performing the transmission.

In accordance with another embodiment, UE 400 may use IuC-information to increase a number of resources to be used for a transmission. For example, in case a UE is required to find a certain percentage of available resources which need to be above a certain CBR, for example, 20% of all resources need to be above the threshold, and in case UE 400 only finds 15%, it may include the available/preferred resources indicated in the IuC information from a potential recipient UE, for example, UE 400 may fill up the missing 5% of resources, so as to achieve the required 20% of resources required for a transmission. Thus, the IuC information may be used to adapt the CBR threshold or, stated differently, to determine the CBR, the UE 400 uses a union of the set of good enough resources determined from sensing and the set resources obtained from the IuC information instead of relying only on the resources obtained by sensing. Thus, although the CBR threshold is fixed to a configured value, by taking one or more resources from IuC, from a perspective of the UE 400, the CBR threshold may seem lower since it may have not chosen these resources from a CBR measurement by itself. Nevertheless, these resource(s) may provide a high enough quality, such that the recipient UE may decode the data successfully.

In accordance with further embodiments, UE 400 may utilize IuC to inform one or more of the further UEs about a future transmission. Since the UEs typically operate in half-duplex mode, this prevents other UEs from transmitting on one of the CCs while the UE 400 is transmitting itself.

Thus, embodiments of the first aspect of the present invention selecting the CCs in accordance with the IuC information are advantageous as it improves the reliability of transmissions performed by the UE because the resource selection at the UE 400 is improved so that, for example, a required percentage of the available resource in the CC, i.e., the percentage of such resources exceeding a certain CBR threshold, may be reached or even improved by supplementing resources below the CBR threshold or even resources above the CBR threshold with preferred/available resources indicated in the IuC information which may meet the CBR threshold or even exceed a CBR of one of the selected resources. Also, using the IuC information, collisions or simultaneous transmissions on the same CC may be avoided. Thus, the overall communication over the sidelink is improved.

In accordance with embodiments, the IuC information may be received from one or more of the further UEs 400-1 to 400-n which are basically capable of communicating with the UE 400 over the sidelink, which however, are not necessarily a communication partner of the UE 400 for a certain SL communication. For example, in case UE 400 is to communicate over the sidelink with UE 400-1, the IuC information may be received from any one of the other further UEs, namely UE 400-2 to UE 400-n. In addition or alternatively, the IuC information may come from the communication partner for the certain SL communication, so that when considering a communication between UE 400 and UE 400-1 over the sidelink, UE 400-1 may provide the IuC information. In accordance with another embodiment, the IuC information may be received from a different transceiver in the device (in device coexistence) e.g., the device has internal an LTE and NR modem, or a WiFi modem and an NR modem, and the other device forwards this information internally to the UE. This may be from an LTE or NR modem, which may perform measurements on a certain CC, or even from a non-3GPP modem, which may be located within the device. This may be a IEEE-based modem, e.g., a Bluetooth or WiFi chipset, which may perform CBR measurement similar to a 3GPP modem or may forward proprietary information with respect to the spectrum usage such as a network allocation vector, NAV, which may indicate the particular frequency and bandwidth as well as duration of usage of the wireless medium. In accordance with yet other embodiments, the IuC information may be provided by one or more of the radio access network entities of the wireless communication system, for example by a roadside unit, RSU, or by a base station, gNB, or by a relay node or by a smart repeater.

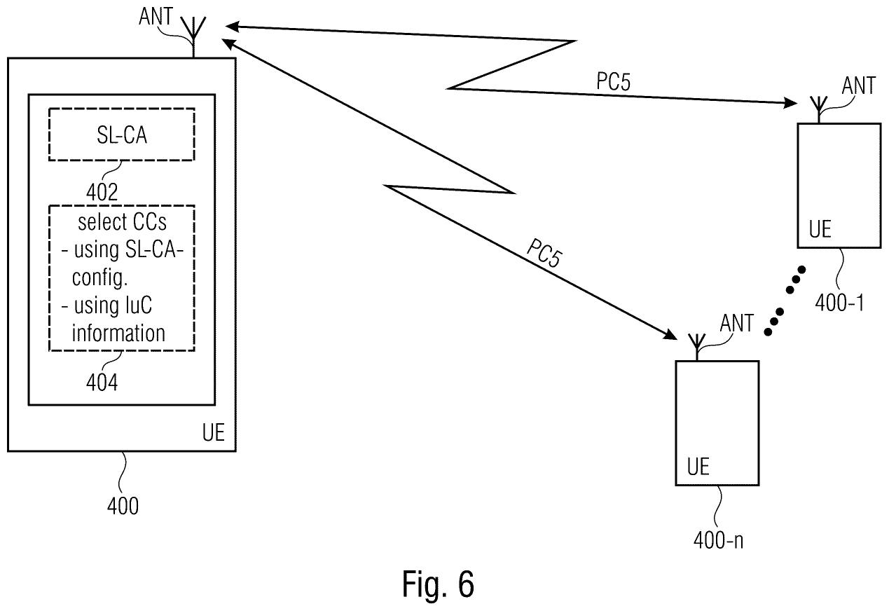

As mentioned above, the IuC information may be provided to UE 400 by one or more of the further UEs 400-1, 400-n, the further UEs being either a communication partner of UE 400 or not. In accordance with embodiments, the IuC information may be transmitted on all CCs used by UE 400. FIG. 7 illustrates an embodiment for transmitting IuC information, like assistance information messages AIMs, for aggregated carriers. FIG. 7 illustrates UE1, which may be UE 400 in FIG. 6, and UE2 which may be one of the further UEs in FIG. 6, like UE 400-1. UE1 operates on three component carriers CC1 to CC3 having a bandwidth of 10 MHz. As is illustrated by the dashed line, each of the component carriers is associated with a certain CBR threshold so that only resources R within a component carrier and exceeding the CBR threshold are used for a communication. UE2 operates on component carriers CC2 and CC3 also of a 10 MHz bandwidth and using, as depicted, only resources R within a CC exceeding the associated CBR threshold. In the embodiment depicted in FIG. 7, UE1 receives from UE2 IuC information for component carriers CC2 and CC3, for example respective AIMs, namely AIM₂ and AIM₃. More specifically, the IuC information for component carriers CC2, CC3 is transmitted on component carrier CC2, for example in a situation in which resources to be used for transmitting IuC information in CC3 are not available, as is depicted by the dotted arrow.

Thus, in accordance with embodiments, the IuC information may be transmitted only on a particular component carrier, like CC2 in FIG. 7, so as to indicate all component carriers on which UE1 may have future transmissions, i.e., also for CCs, like CC3, on which UE1 is currently not transmitting. In accordance with other embodiments, UE1 may receive the IuC information on all CCs used by UE1. UE1 may receive the respective IuC information, like respective AIMs on both CC2 and CC3 in FIG. 7, either from UE2 and/or from other UEs and/or from a RSU. The IuC may contain information only for a particular CC, for example regarding future transmissions, or, in accordance with other embodiments, may contain information for more than one CC on which the UE₁ has future transmissions, for example also CCs in which UE₁ is currently not transmitting.

In accordance with further embodiments, the IuC information may be transmitted to do one or more of the following:
inform the further UE about resource collisions, e.g., caused by other transmissions,
inform the further UE about preferred resources or non-preferred resources, e.g., resources which are interference-free or which may cause interference to the UE,
request IuC information from the further UE,
a request for positioning information, e.g., a geolocation or reference signals, PRS,
a wake-up signal (WUS),
a mobility state,
   a handover-related information, e.g., a handover configuration like a preferred set of gNBs, or a CHO configuration.

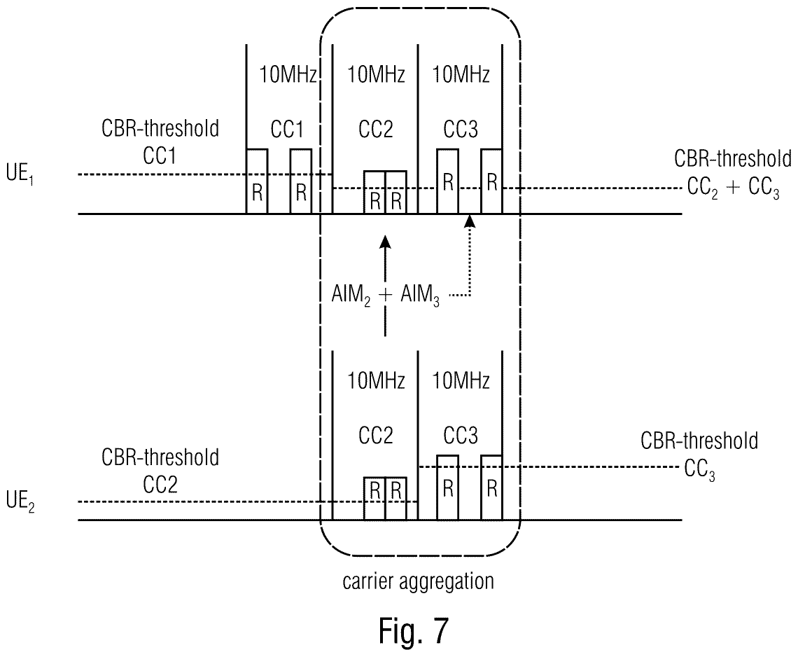

Embodiments of the first aspect of the present invention have been described in detail above, and it is noted, that the mentioned embodiments may be implemented separately or in combination. FIG. 8 illustrates a combination of the above-described embodiments of the first aspect implementing cast-type specific component carriers and employing IuC information. FIG. 8 illustrates UE1, which may be UE 400 in FIG. 6 performing carrier aggregation and using two component carriers CC1 and CC2 having a bandwidth of 10 MHz. Within the respective component carriers, UE1 employs only the resources R fulfilling the CBR thresholds for CC1 and CC2, respectively. FIG. 8 illustrates an embodiment in which UE1, in accordance with a SL-CA configuration has associated CC1 with unicast transmissions to one of the further UEs, like UE 400-1 in FIG. 6, while component carrier CC2 is used for a broadcast so as to transmit/receive to/from a plurality of the further UEs, like UEs 400-1, 400-n in FIG. 6. In addition, as is indicated in FIG. 8, the component carrier CC2 being used for broadcast also receives the above described IuC information from one or more of the further UEs or from one of the radio access network entities for supporting UE1 in selecting its resources for performing transmissions on CC1 and/or CC2 as has been described above in more detail.

### Second Aspect

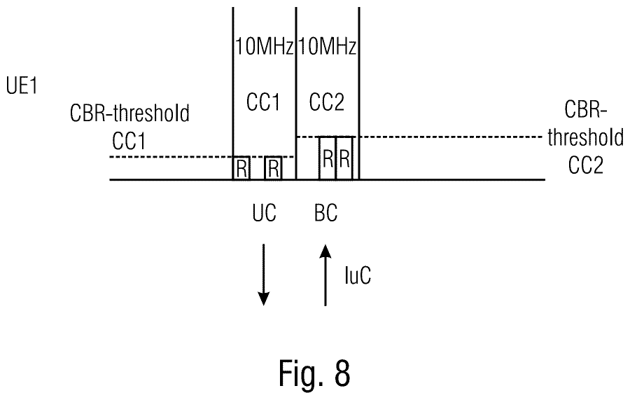

Embodiments of the second aspect of the present invention are described. FIG. 9 illustrates a user device, UE, 500 according to an embodiment of the second aspect of the present invention. UE 500 is operating in a wireless communication network, like the wireless communication network illustrated above with reference to FIG. 1 or to FIG. 2. UE 500 communicates with one or more further UEs 500-1 to 500-n over a sidelink, as is illustrated schematically by the PC5 connections. As is schematically illustrated at 502, UE 500 supports sidelink carrier aggregation, SL-CA, which comprises a plurality of component carriers, CCs. UE 500 selects one or more or all of the CCs for transmitting to or receiving from a further UE, like UE 500-1. UE 500, as is schematically illustrated at 504, selects one or more or all of the CCs for transmitting to or receiving from a further UE 500-1, such that UE 500 and the further UE 500-1 use the same CC combination or a CC combination that includes at least one or more carriers that are used by the further UE 500-1. In other words, UE 500 operates, as indicated at 504, such that among the available CCs a selection is made so as to obtain a suitable combination of CCs for a communication with the communication partner for the sidelink communication, like UE 500-1.

The second aspect of the present invention is advantageous as it ensures that respective component carriers to be used for a communication between UE 500 and, for example, UE 500-1 over the sidelink are aligned so as to allow for a reliable and efficient communication.

In accordance with embodiments, UE 500 may operate in Mode 2, i.e., without control of a base station or the network, as has been described above with reference to FIG. 2(B). Also in such an operating mode, the CCs between the UEs need to be aligned and in case there is more than one possible CC combination, the UEs involved in performing a communication using CA need to coordinate which carriers to use for transmitting and/or receiving. The advantage of a coordination in accordance with the second aspect of the present invention is that less power is wasted since the spectral density is optimized to confine most power to lesser bands. Moreover, less sensing and/or less blind decoding is needed, since the UEs know where to expect a transmission, i.e., which of the component carriers may actually be employed for the communication.

UE 500, in accordance with embodiments, may perform carrier switching so as to select the CCs for transmitting to or receiving from the further UE 500-1. Carrier switching may involve the UE to completely switch to a different band, e.g., a neighboring band, or even switch its transceiver to a completely different center frequency, e.g., by tuning its transceiver from a carrier operating in FR1, having a center frequency below 6 GHz, to FR2, having a center frequency above 6 GHz.

The benefit of carrier switching is that the device may operate on a smaller bandwidth, since it does not per-se aggregate bandwidth, but just switches from on band to another. Furthermore, it may switch to a band which has a better transmit or receive quality, e.g., with respect to SINR and/or with respect to a beamforming gain or it may even switch to a different bandwidth part, BWP, supporting a lower or higher numerology. A higher numerology may be beneficial since it may support the UE to perform transmissions with lower delay.

In accordance with further embodiments, UE 500 may use the selected CCs, i.e., a certain combination of CCs for a certain communication only until a certain event is encountered, and then UE 500 may automatically switch back from using the selected CCs, to a certain CC configuration, for example to a previously used CC configuration, prior to performing SL-CA, or to a configured or pre-configured default CC configuration. For example, the default CC configuration may be that the UE is configured with carrier aggregation using a certain band combination, e.g., two neighboring CCs in the ITS band, or the default configuration may be that the UE does not use CA at all, but rather a single CC with a specified center frequency and bandwidth. In this case, the UE may either not use CA anymore or may switch back to a CC combination it has used prior to being configured with its current carrier combination. Furthermore, the UE may also switch back to a default CC configuration, e.g., using an ITS band or using a configured or pre-configured carrier or carrier combination or a fail-safe carrier configuration, which it was configured or pre-configured with or which is known to the said UE, e.g., by the firmware stored within the UE. In this way, the UE may switch to a valid carrier configuration, which may be important in case the UE loses connectivity to a cellular network or in case it experiences RLF to other UEs within its vicinity.

In accordance with other embodiments, UE 500 may switch back to using only a single component carrier, i.e., stops using SL-CA. For example, the UE may switch to a different carrier, e.g., with a different center frequency . . . . In accordance with further embodiments, UE 500 may switch to a different bandwidth part, BWP, e.g., having a different center frequency, bandwidth and/or numerology. In accordance with yet other embodiments, UE 500 may switch modes, for example from SL Mode 2 to SL Mode 1, or vice versa. The advantages here are that the UE may automatically switch back to a known mode, as well as perform power saving, since it only needs to perform sensing and blind decoding on a smaller bandwidth. Furthermore, as already mentioned above, this enables the UE to switch back to a fail-safe mode, which is also known by other UEs in its vicinity. Thus, in case of RLF, also surrounding UE may be aware of the band that they may use to try to reestablish a link to the said UE. Further, also the network may also be aware of this procedure and may thus use its knowledge to reach a UE. This may be beneficial in case of RLFs or in case a UE needs to be reconfigured by the network due to other reasons, e.g., the network provides an updated sidelink configuration to the said UE.

In accordance with embodiments, the above-mentioned event for automatically switching back from a selected set of CCs may be, as mentioned above, a completion of the SL communication with the further UE 500-1. For example, a transmission to and/or a reception from the further UE 500-1 may be completed or an expected feedback message is received or transmitted, like a HARQ-ACK or a HARQ-NACK is received/transmitted from/to the further UE 500-1. Another event may be that a certain duration or time period during which nothing has been transmitted and/or received on the selected CCs exceeds a configured or pre-configured threshold, for example a timeout while waiting for a HARQ feedback. Yet another event may be that the CBR on one, some or all of the selected CCs is above a configured or pre-configured threshold so that the respective CCs are busy and may no longer guarantee the communication. The event may further comprise one or more of the following:
a number of decoding errors on data transmitted on the selected CCs exceeds a predefined threshold, e.g., too many HARQ-NACKs are received
a number of LBT-failures exceeds a (pre-)configured threshold,
power saving purposes: e.g., the power budget exceeds a (pre-)configured threshold, and/or the UE needs to perform DRX,
an emergency situation, e.g., the UE receives an emergency indicator, e.g., emergency code.

In accordance with embodiments of the second aspect of the present invention, for implementing the suitable combination of CCs to be used for a communication, for example, with UE 500-1, UE 500 may provide respective information to UE 500-1, for example by sending a message to UE 500-1. The message may include information on one or more time windows during which UE 500 is receiving on a certain CC. Also, a conflict indication may be indicated, for example indicating when UE 500 is not capable of receiving due to a switching gap, e.g., when switching from transmission to reception or vice versa, or due to a reception on a different or another CC. Also, a default CC may be signaled that the UE 500 is receiving unless the UE 500 switches for reception to a different CC. The message may also include one or more DRX patterns/configurations for the selected CCs. Signaling of a default CC is beneficial, since the said UE may then switch to this default CC when a transmission is finished or when moving from IDLE and/or INACTIVE to CONNECTED state, e.g., in case it has data to transmit. This may allow the UE to move to a well-defined CC. Also, other surrounding UEs may be aware of this default configuration. Furthermore, when UEs are operating in Mode 2 without control of a base station, it may not be possible to align carriers via the network configuration, e.g., via RRC signaling from the network. Thus, such a default configuration may allow UEs to be in a well-defined state, especially, during initial setup or when switching modes or when switching on, e.g., waking up from a sleep-mode. In addition, it may be beneficial to signal DRX-related information for this CC, since each CC may have a different DRX-cycle, dependent on the number of UEs using this carrier. In case it is a default carrier, it may be used more frequently used by a larger number of UEs. Thus, the particular DRX configuration may contain fields contained in the DRX-config, see ETSI TS 138 331 V17.4.0 (2023-05), most important the drx-onDurationTimer, indicating the amount of time at the beginning of each DRX cycle, as well as the drx-InactivityTimer, indicating the UE's preferred DRX inactivity timer length for power saving. On the contrary, the default CC may have to be monitored more frequently by a UE, resulting in a particular DRX configuration for this carrier. Further, a default CC may be realized using a smaller bandwidth, since it is rather used for control and for managing UEs, which may reduce the decoding effort and safe power, since less bandwidth has to be processed at each UE.

In accordance with embodiments, the coordination between UE 500 and UE 500-1, for example for conveying the above-mentioned information from UE 500 to UE 500-1, may be according to a specification of the wireless communication network, like the NR specifications, i.e., the UEs are pre-configured accordingly, or by using a specific signaling, for example for sending the above-mentioned message. The signaling may employ PC5 RRC, or MAC CEs or SCIs. In accordance with other embodiments, the information may be conveyed via a resource pool configuration or via a handover or conditional handover, CHO, configuration exchange. For example, UE 500 may indicate its CC combination to the other UE 500-1 to make sure than both UE 500 and UE 500-1 use the same CC combination or a CC combination that includes at least all carriers that are used by UE 500-1. The just mentioned signaling may be employed in situations in which, for example, UE 500 operates in Mode 2. In accordance with other embodiments, when the UEs operate in Mode 1, the signaling may be via a RAN entity, for example a UU signaling via a base station or gNB using UCI.

In accordance with further embodiments, UE 500 may perform, for example when it is operating in Mode 2, a resource selection based on the channel busy ratio, CBR, and only those resources are selected for the SL transmission which are above a predefined or configured CBR-threshold. Moreover, UE 500 restricts the resource selection to resources of the CCs used by the UE 500 and by the further UE 500-1 for the sidelink communication. Thus, UE 500 does not select resources from a certain CC if the set of resources available on the certain CC is below a configured or pre-configured threshold, like the CBR-threshold. In other words, in accordance with embodiments of the second aspect of the present invention, the coordination of the CCs may be configured or pre-configured by restricting resource selection, e.g., for an upcoming transmission, by excluding resources in the resource selection when one or more of the following applies:
A feedback is expected, like a HARQ-feedback. Restricting the resource selection in a such a scenario is advantageous as it ensures that sufficient resources are available on a component carrier so that the feedback may be reliably received at UE 500.
Beam management control traffic is expected, for example, a beam failure recovery, BFR, indication and the like. This is advantageous as by selecting within a CC resources exceeding, for example, the CBR-threshold, the beam management control traffic is reliably received at UE 500.
The UE expects to receive positioning-related information, e.g., PRS.
The UE expects to receive channel state information, e.g., CSI.
The UE expects the reception of control signals and/or data signals and/or feedback signals and/or synchronization signals from another UE, like UE 500-1, which, e.g., has been previously indicated via the PSCCH Time Resource Indicator Value/Frequency Resource Indicator Value, TRIV/FRIV, signaling transmitted within the sidelink control information, SCI. By analyzing the TRIV/FRIV of other UEs, the UE may be aware about n future reservation of resources, e.g., n=3, and thus it may avoid selecting these resources and thus avoid resource collisions with other UEs transmitting within its vicinity. In case it may be aware about the location of the other UE having conflicting resources, and in case the other UE may move away into a different direction, and/or in case the said UE may transmit into another direction to a further UE, e.g., using beamforming, the UE may also decide to reuse one or more of the resources which may be potential conflicting, since the probability of a resource collusion may be less, especially for moving UEs, e.g., as in V2X. Further, this probability may be signaled or specified, such that a UE may calculate a probability of a potential resource conflict and in case this is below a configured or pre-configured threshold, the UE may decide to transmit on the said resource.
A channel access procedure, CAP, for a high priority application is employed, for example, the communication over the sidelink makes use of the unlicensed spectrum. A certain CC in the carrier aggregation may be restricted to allow only a certain CAP or may not allow performing a certain CAP. This approach is advantageous as it makes sure that when employing one or more CCs from the unlicensed spectrum an appropriate CAP is selected.
The UE is already performing a transmission on another CC, like a neighboring CC or on a CC with a certain distance offset with regard to the carrier frequency of the currently used CC. This avoids interferences and improves the communication.
The resources are excluded from the resource selection in the sensing procedure, e.g., before performing the resources selection.

In the embodiments described above, certain resources have been excluded from the resource selection during the sensing procedure. However, in accordance with other embodiments, UE 500 may apply a penalty factor or penalty threshold, e.g., 3 dB on the resources or on the selection of a certain CC so as to avoid selecting such resources or to avoid a transmission on a particular CC at all for the upcoming transmission.

The upcoming transmission may be a data transmission or a control transmission. It may also be a feedback transmission, e.g., PSFCH HARQ-ACK/NACK or a HARQ-NACK-only. The transmission may also be a IuC transmission, for example a transmission of preferred or non-preferred resources or of a collision indicator, CI. Moreover, the upcoming transmission may be a transmission of a synchronization signal, like the S-SSB, or a beam management or beam maintenance control signal. This may be applied to the above transmissions to protect these transmissions. It may be preferable to use a penalty factor, since in case a resource with applied penalty factor is below a certain threshold, it may still be beneficial to use or not to use this resource for a data transmission by the UE, e.g., in case the resource is too interfered, it may be avoided to be used for important control messages, e.g., such as transmitting the PSFCH. In case the UE has an urgent data message to transmit, a different penalty factor may be applied, e.g., a smaller penalty factor or even a negative penalty factor, which may increase the likelihood of the UE to find an adequate number of resources for a transmission. A negative penalty factor may allow to even use the said resource as a preferred resource, which may be beneficial for data/control traffic having a very high priority, e.g., a high 5QI value. Thus, introducing a penalty factor may allow a more flexible way to adjust resource selection of the UE.

In accordance with embodiments, different penalty factors or thresholds may be applied dependent on certain situations, e.g., dependent on one or more of the following:
The priority of a transmission. For example, the higher the priority of the transmission is, the lower the penalty factor is, resulting in a higher probability to use the resource for the high priority transmission. On the contrary, for low priority transmissions, the likelihood of selecting this resource may be very small, which may protect other data and/or control traffic to be transmitted on the said resource by this UE and/or other UEs . . . .
The QoS-requirement: For example, if data with ultra-low delay requirements is to be send, the data might be preferred to be send over a larger frequency bandwidth, which might only be possible doing carrier aggregation.
The cast-type: it may be preferred to transmit resource of a given cast-type, e.g., groupcast or multicast messages, since these may be safety-related, e.g., BSM, and send via groupcast to inform a certain group in the vicinity of the UE about an emergency situation, e.g., a road hazard. Here, a group may be all vehicles, or all pedestrian-UEs, P-UEs, and thus groupcast may be chosen for a certain high priority message. There may be other situations, where broadcast is preferred, in case all UEs within the vicinity of a said UE are to be informed. Furthermore, this may be also used for unicast transmissions, in case a UE knows that a particular UE within its vicinity may be involved, e.g., a potential V2X-UE to be involved in a predicted car crash, thus it may make sense to only send a certain safety message to this particular UE.
The type of the transmission, e.g., for safety related transmissions, e.g., BSM, it may be beneficial to apply or not to apply this penalty factor. On the contrary for normal data transmissions, it may be beneficial to apply this penalty factor, in order to prefer other messages, such as BSM as well as control messages, transmitted by this or other UEs.
Other transmissions, like transmissions in neighboring bands which may cause interference on a currently used CC. These are transmissions in other CCs which may be CCs located next to the CC used by the said UE, e.g., causing adjacent power leakage, ACLR, to the said CC, or these may be caused by transmissions on CCs in different bands. In general, such impairments may be caused by the modulation process and non-linearity in the transmitter. Furthermore, spurious emissions are emissions caused by unwanted transmitter effects such as harmonics emission, parasitic emission, intermodulation products, and frequency conversion products, which may cause additional impairments to transmissions in a said CC.

### Third Aspect

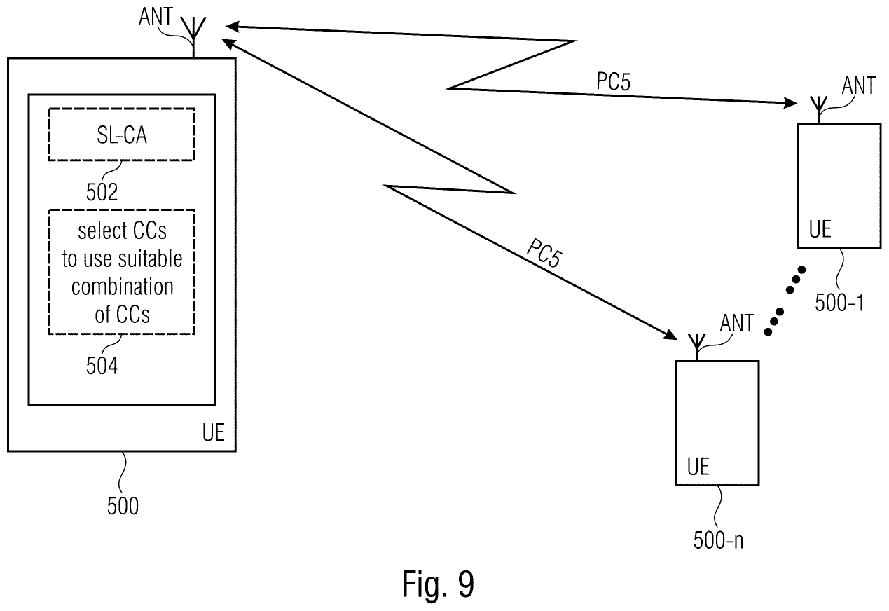

Embodiments of the third aspect of the present invention are described. FIG. 10 illustrates a user device, UE, 600 according to an embodiment of the third aspect of the present invention. UE 600 is operating in a wireless communication network, like the wireless communication network illustrated above with reference to FIG. 1 or to FIG. 2. UE 600 communicates with one or more further UEs 600-1 to 600-n over a sidelink, as is illustrated schematically by the PC5 connections. As is schematically illustrated at 602, UE 600 supports sidelink carrier aggregation, SL-CA, which comprises a plurality of component carriers, CCs. UE 600 selects one or more or all of the CCs for transmitting to or receiving from a further UE, like UE 600-1. UE 600, as is schematically illustrated at 604, may perform a pre-emption so that in case of an upcoming certain transmission, like a priority transmission, UE 600 skips one or more resources out of a periodic transmission in order to transmit and/or receive the certain transmission on another CC or on the same CC or on the aggregated CCs. In other words, UE 600 implements SL-CA in such a way that pre-emption techniques are used to as to prioritize resource selection, carrier selection or perform carrier aggregation so as to allow evacuating one or more carriers or component carriers in case another transmission, the above-mentioned certain transmission, is to be performed.

The certain transmission may be a transmission on one of the sidelink CCs, it may be a transmission on a UU component carrier, like an uplink transmission, for example a high priority transmission from UE 600 to a base station serving UE 600, or it may be a transmission in an unlicensed band, e.g., a WiFi transmission. In other words, the certain transmission may be a transmission having a priority exceeding a certain threshold, for example an absolute threshold. In such a case, the certain transmission as well as the periodic transmission have respective priorities associated therewith and the priority of the certain transmission is simply higherthan that of the periodic transmission. In accordance with other embodiments, rather than using an absolute threshold, also a threshold relative to the priority of the periodic transmission may be employed so that not only the certain transmissions having the highest priority are transmitted using the pre-emption approach but any transmission having a priority higher than the periodic transmission . . . . In accordance with other embodiments, the certain transmission has a higher QoS, e.g., with respect to the latency requirement and/or data volume and or service class, e.g., small data, guaranteed bit-rate (GBR) or delay critical GBR, as defined by the 5G QoS (5QI) table.

A pre-emption causes one or more resources of the periodic transmission to be skipped so as to transmit the certain transmission, like a data/control/feedback/synchronization signal on another or on the same or on an aggregated carrier. This may be employed, in accordance with embodiments, if a transmission is of urgency, for example containing feedback for a higher priority transmission. In such a case, UE 600 may cancel a transmission in order to provide the feedback which may be done across carriers. This may also be applied for other transmissions, for example for a communication exchanging beam management-related information, like BFR, beam-pairing and the like so as to allow performing a beam-sweep at a given time instance to find or fine-tune a beam-pair link. In such a scenario a simultaneous transmission is not possible. In accordance with other embodiments, pre-emption may also be employed when exchanging synchronization signals, for example a transmission on a first component carrier may be cancelled so as to allow performing a re-synchronization process on another component carrier.

The third aspect of the present invention is advantageous as it allows implementing the advantages of the pre-emption approach also for SL-CA so that also in such communication scenarios certain transmissions may be transmitted despite an ongoing periodic transmission thereby efficiently and reliably transmitting the certain transmission.

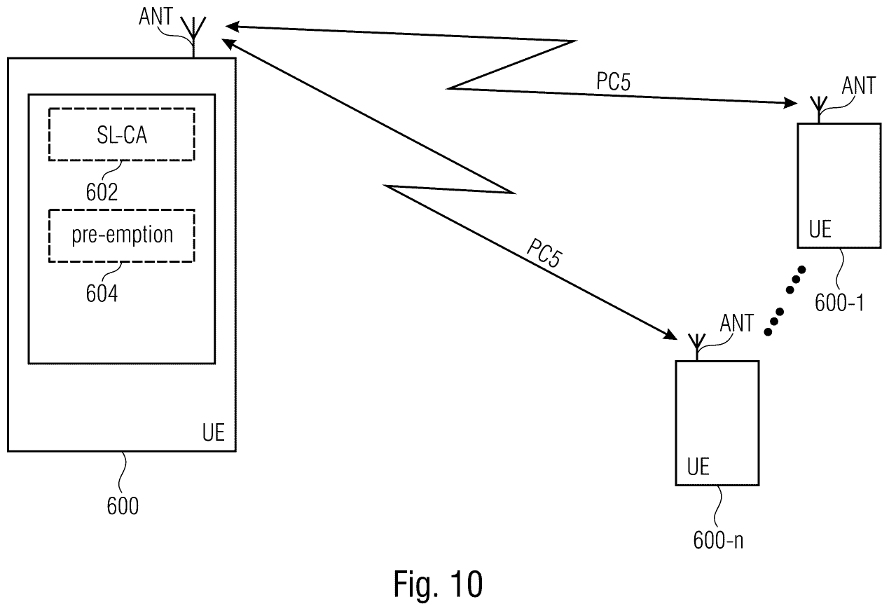

FIG. 11 illustrates an embodiment of the third aspect of the present invention applying pre-emption of a periodic transmission to perform a carrier selection for a high high-priority transmission. FIG. 11 illustrates, schematically, UE 600 implementing SL-CA by aggregating component carriers CC1 to CC3. The component carriers have a bandwidth of 10 MHz and within each component carrier respective resources R are employed which exceed the CBR-threshold associated with the respective CC. UE 600 performs a periodic transmission P on component carrier CC1. The periodic transmission comprises transmissions at times t1, t2 and t3. Before time t2 UE 600 becomes aware of a high-priority transmission H to be performed at t2. In accordance with embodiments, UE 600 cancels the transmission of the periodic transmission P at time t2, switches to component carrier CC2 and performs the high-priority transmission H at time t2 instead of the periodic transmission P. At time t3 UE 600 resumes transmission of the periodic transmission. It may be beneficial to perform carrier switching for the UE in this case, in order to reduce power consumption in the UE, since the said UE may only transmit on a smaller carrier and thus increase its power spectral density. Furthermore, this may also involve the UE to perform sensing or listen-before-talk, LBT, prior to its transmission on the carrier the UE is switching to, which may be less power hungry in case the carrier may have a smaller bandwidth.

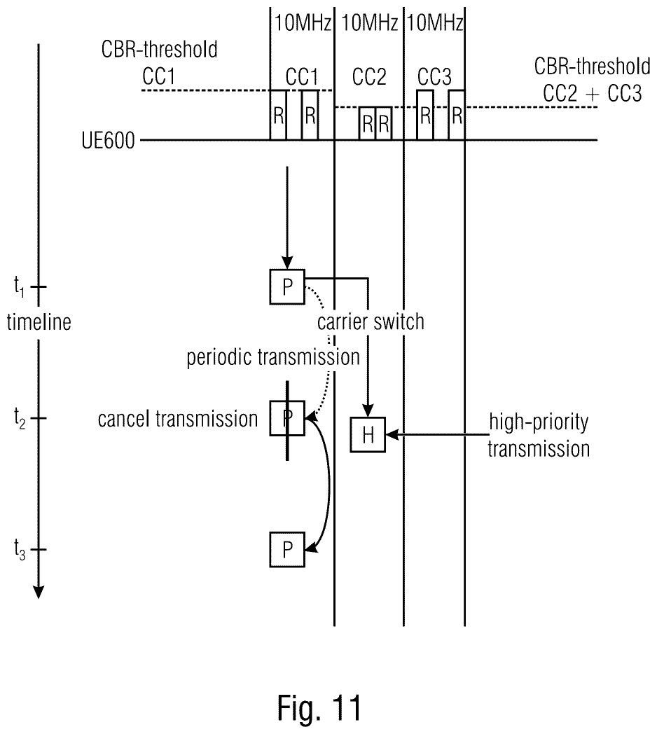

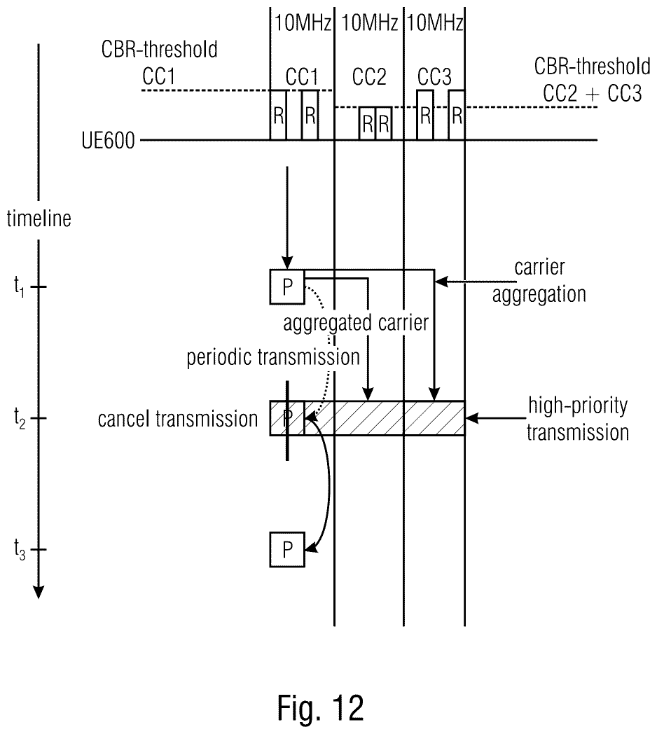

FIG. 12 illustrates another embodiment of the third aspect of the present invention in accordance with which the pre-emption of the periodic transmission is used to perform a high priority transmission on aggregated carriers. FIG. 12 illustrates a scenario similar to FIG. 11 except that when determining that a high-priority transmission H is to be performed while performing the periodic transmission P, UE 600, after cancelling the periodic transmission P at time t2 performs carrier aggregation so as to use all component carriers CC1 to CC3 for transmitting the high-priority transmission H.

In accordance with further embodiments, the certain transmission comprises one of the following:
a data signal,
a control signal,
a feedback signal,
a synchronization signal,
beam management-related information,
a measurement signal, e.g., a signal containing channel state information, CSI, or channel quality related information,
a wake-up signal, e.g., WUS
a positioning reference signal, e.g., PRS.

### Fourth Aspect

Embodiments of the fourth aspect of the present invention are described. FIG. 10 illustrates a user device, UE, 700 according to an embodiment of the fourth aspect of the present invention. UE 700 is operating in a wireless communication network, like the wireless communication network illustrated above with reference to FIG. 1 or to FIG. 2. UE 700 communicates with one or more further UEs 700-1 to 700-n over a sidelink, as is illustrated schematically by the PC5 connections. As is schematically illustrated at 702, UE 700 supports sidelink carrier aggregation, SL-CA, which comprises a plurality of component carriers, CCs. UE 700 selects one or more or all of the CCs for transmitting to or receiving from a further UE, like UE 700-1. UE 700, as is schematically illustrated at 704, performs data duplication by sending a data packet over a first CC and an exact copy thereof or an additional redundancy version thereof over a second CC, with the first and second CCs being different.

Embodiments of the fourth aspect of the present invention are advantageous as the data duplication, by sending an exact copy or an additional redundancy version of a data packet over a different set of resources, increases the probability of a successful decoding at a receiver of the transmission, like UE 700-1. For example, data duplication may be used in addition to a repetitive transmission, like retransmissions using HARQ, with the benefit that data duplication enables parallel transmissions, also within the same time resources, e.g., OFDM symbols and/or slots and/or frames and/or subframes, and without the need to wait for an ACK/NACK from the intended receiver.

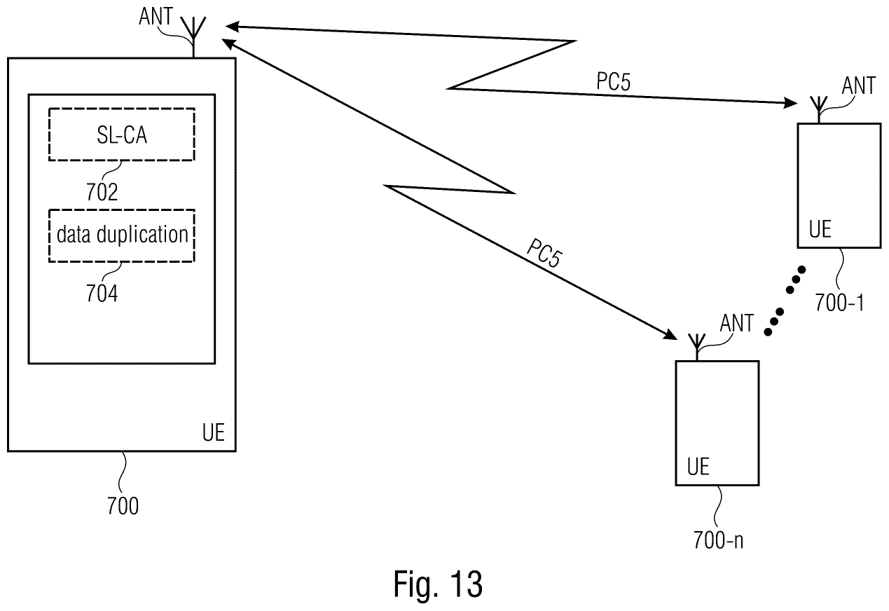

FIG. 14 illustrates an embodiment for implementing data duplication using UE 700. UE 700 is assumed to perform sidelink carrier aggregation by aggregating component carriers CC1 to CC3 each having a bandwidth of 10 MHz. Within the respective CCs, resources R are used for the communication which exceed the CBR-threshold associated with the respective CC. In FIG. 14, it is assumed that UE 700 performs a transmission of a data packet P at a certain time using the resources R of the second component carrier CC2. UE 700 applies data duplication and transmits at the same time using resources from component carrier CC3 the duplicate D, which, as mentioned above, may be an exact copy of P or may be a redundancy version of P.

In accordance with embodiments, data duplication may be utilized for transmissions where low delay is important since the transmitter, like UE 700, does not have to wait for an ACK/NACK before sending a copy of the data packet or a redundancy version thereof. In accordance with embodiments, the data duplication mechanism may be used in addition to the HARQ retransmission or even without any HARQ configuration.

In accordance with embodiments, UE 700 may perform a data duplication on the component carriers responsive to the UE and/or the data packet P meeting one or more criteria. The mentioned criteria to perform or not to perform data duplication may include one or more of the following:
A priority or a QoS parameter of the data packet exceeding a predefine threshold so that important transmissions associated with such a priority or QoS parameter, e.g., a 5QI value, are transmitted with an improved the reliability.
In case the transmitter UE, like UE 700, is not sure whether the receiver UE listens on a particular component carrier. This is advantageous as it avoids situations in which, despite a coordination of the component carriers, the receiving UE, like UE 700-1, may not be capable of receiving the data packet P on CC2 (see FIG. 14) but it may be is capable of receiving on CC3 so that, despite the fact that no reception on CC2 is possible, the data transmitted by UE 700 is received at the further UE 700-1 on CC3.
In case the data packet is to be transmitted according to a certain cast-type, for example, a data duplication may be employed for any broadcast and/or groupcast and/or unicast communication which is advantageous as in such scenarios even when one or more among the multiple receivers of the broadcast/groupcast transmission do not receive on one of the CCs, by means of the data duplication, the information is also provided on another CC on which the respective UEs may receive.
In case the quality on a second CC is above or at a pre-defined threshold, like a CBR-threshold or based on the interference, e.g., SINR. As is depicted in FIG. 14, the CBR-threshold for CC2 and CC3 are the same, so that UE 700 may decide to perform data duplication on CC3. Determining data duplication dependent on a CBR threshold on the second CC to be at or above the CBR-threshold of the first CC is advantageous as it makes sure that the transmission of the duplicate is on a CC using resources which fulfil at least the same requirements as the resources on which the original data packet is transmitted. In case the CBR threshold is set higher than the threshold at the initial CC, the advantage is that the transmission may be even of better reliability than on the initial CC. In the case that the quality of the resources on a second CC used for duplication are below a predefined threshold, this CC may still be used for a transmission of a redundancy version, since the said data packet may be combined at the receiver and there may still be a chance that it is decoded successfully. Thus, especially for a last retransmission, it may be beneficial to use this brute-force method in order to avoid a retransmission on a higher layer, which may cause much larger delays. Note, that retransmissions on the MAC-layer or even on the application layer are handled on a much larger time scale, than retransmissions on the physical layer, PHY.
In case there is a sufficient number of CCs available, i.e., at least one additional CC meeting the CBR-threshold requirement is available for transmitting the duplicate of the data packet P.
In case LBT failures exceed a number of configured or pre-configured number, e.g., in case the UE is operating on an unlicensed carrier as in sidelink unlicensed (SL-U).
Depending on the UE's battery state, e.g., in case the UE has low battery, the said UE might want to perform data duplication to increase the probability of a successful transmission and to avoid retransmissions, to go into an DRX mode as fast as possible.
The UE being triggered to perform duplication by another device, e.g., by another SL UE, e.g., by a control message, e.g., IuC.

In accordance with embodiments, the UE, like UE 700, may receive inter-UE coordination, IuC, messages or assistance information messages, AIMs (see also the first aspect of the present invention) for a certain component carrier. In case the receiving UE, like UE 700-1, transmit a set of non-preferred resources to the transmitter UE, like UE 700, UE 700 may refrain from performing data duplications, thereby saving power and avoiding transmitting on more than one carrier. In case UE 700 receives a set of preferred resources via the IuC, UE 700 may be triggered to perform data duplication.

### General

Embodiments of the present invention have been described in detail above, and the respective embodiments and aspects may be implemented individually or two or more of the embodiments or aspects may be implemented in combination.

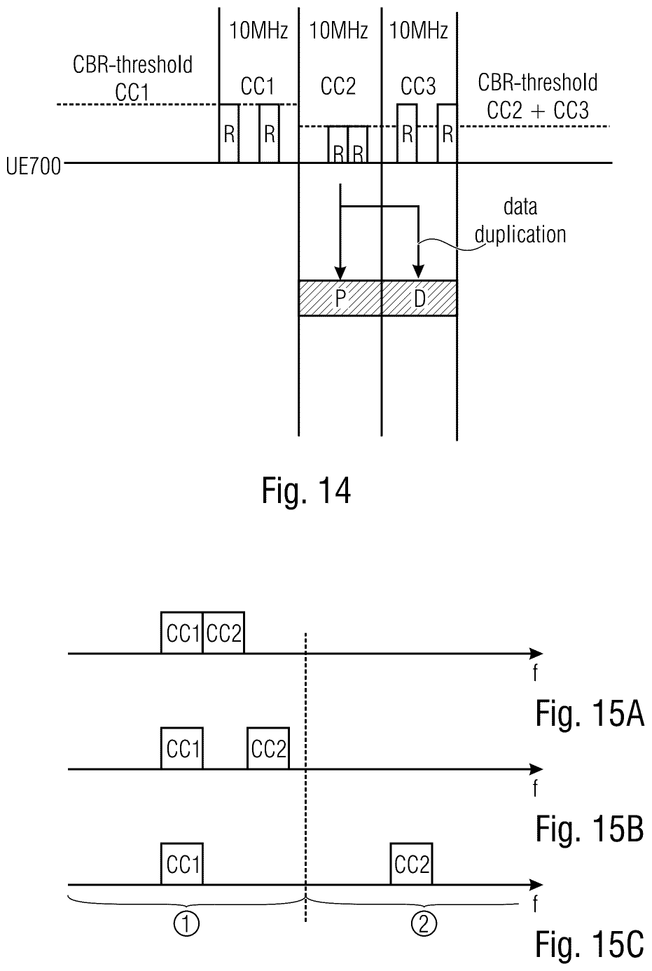

In the above described embodiments of the first to fourth aspects, sidelink carrier aggregation has been described with reference to an intra-band continuous aggregation. However, the present invention is not limited to such embodiments, rather, also an intra-band, non-continuous aggregation or an inter-band, non-continuous aggregation may be employed. FIG. 15 illustrates the just mentioned aggregation alternatives which may be applied in accordance with embodiments of the present invention. FIG. 15(A) illustrates the intra-band, continuous carrier aggregation in which the component carrier CC1 and CC2 are continuous within the frequency band \textcircled{1}. FIG. 15(B) illustrates the intra-band, non-continuous carrier aggregation in accordance with which the component carriers CC1 and CC2 are spaced in frequency in the frequency band \textcircled{1}. FIG. 15(C) illustrates the inter-band, non-continuous carrier aggregation in which the component carriers CC1 and CC2 are in separate frequency bands \textcircled{1} and \textcircled{2}.

Although FIG. 15 illustrates only two CCs, more than two CCs may be aggregated. For example, in FIG. 15(A) one or more additional CCs may be contiguous with CC1 and CC2, e.g., with one additional CC as shown in FIG. 3, FIG. 4, FIG. 7, FIG. 11, FIG. 12 or FIG. 14. Also in FIG. 15(B) and in FIG. 15(C), CC1 and/or CC2 may be may be contiguous with one or more additional CCs.

Further, the present invention ids not limited to all CCs having the same bandwidth of 10 MHz, as described in the above embodiments. Rather, in accordance with other embodiments, the CCs may have different bandwidths, e.g., a CC may have a bandwidth of 1.4 MHz, 3 MHz, 5 MHz, 15 MHz or 20 MHz. The different CCs may have the same bandwidth or some or all of the CCs may have different bandwidths. Moreover, a maximum of number of CCs, e.g., five component carriers, and/or a maximum aggregated bandwidth, e.g., 100 MHz, may be defined or predefined.

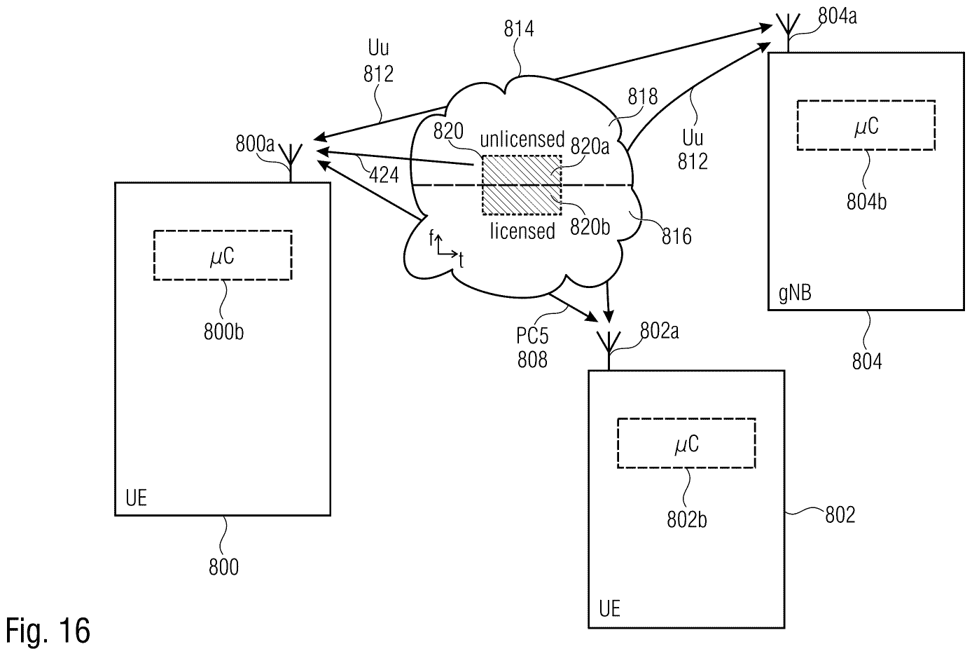

Further, the above-described embodiments refer to an operation of the user devices over the sidelink using resources from the licensed spectrum. However, the present invention is not limited to an operation in the licensed spectrum, rather, further embodiments may implement a sidelink communication using exclusively or at least in part resources from the licensed spectrum as is illustrated in FIG. 16 which illustrates a wireless communication system, like the one described above with reference to FIG. 1 or FIG. 2, for example a 3^{rd} generation partnership project, 3GPP, system or network. The wireless communication system includes the user devices 800, 802 and one or more base station 804. UE 800, also referred to as sidelink UE, SL-UE, and operating in accordance with embodiments of the above-described aspects of the present invention, comprises one or more antennas 800a and a signal processor 800b for performing one or more operations, for example operations involving the antenna 800a, like transmitting/receiving data, e.g., payload data or control data, or inter-UE coordination (IuC) messages. UE 800 may communicate with other UEs, like UE 802, using the sidelink or PC5 interface, as is schematically illustrated at 808. UE 802, also referred to as sidelink UE, SL-UE, and also operating in accordance with embodiments of the above described aspects of the present invention, comprises one or more antennas 802a and a signal processor 802b for performing one or more operations, for example operations involving the antenna 802a, like transmitting/receiving data, e.g., payload data and/or control data, or inter-UE coordination (IuC) messages. Moreover, UE 800 and/or UE 802 may be connected to a base station or gNB 804. The gNB 804 includes one or more antennas 804a for the wireless communication with the other network entities, like UEs 800 and/or 802, and a signal processor 804b. When operating in Mode 1, UE 800 and UE 802 receive via the Uu interface 812 resources allocated by the gNB 804 that are to be used by the UE for the communication over the sidelink 808. When operating in Mode 2, UE 800 and/or UE 802 may not have a connectivity to the gNB 804 and a sensing plus access resource allocation or a random access-based resource allocation is performed by the UE prior to performing a transmission. FIG. 16 further illustrates, schematically, the spectrum 814, like the radio spectrum including the resources to be used for a communication within the wireless communication system or network. The resources available for the SL communication may comprise one or more of the following: one or more symbols, one or more time slots or subframes or frames, one or more resource blocks (RBs) or frequencies or carriers or subchannels or groups of subchannels, one or more frequency bands. As is further illustrated, schematically, the spectrum 814 comprises the licensed spectrum 816 and the unlicensed spectrum 818. The licensed spectrum 816 is the part of the spectrum that is reserved for the wireless communication system including the UEs 800 and 802 as well as the base station 804. In other words, resources in the licensed spectrum are for exclusive use by this wireless system, as defined by regulatory bodies and entities. The unlicensed spectrum 818 includes resources that may be used by a plurality of wireless communication systems, for example by another wireless communication system in accordance with the 3GPP standard but operated by a different operator, or by systems using a different radio access technology, RAT, like WiFi or Bluetooth. For the sidelink communication a resource pool 820, also referred to as sidelink resource pool, SL-RP, may be provided, and UE 800 is configured or preconfigured with the resource pool 820. Although the figure depicts only a single resource pool, multiple such resource pools may be configured or preconfigured. The resource pool may include resources from the unlicensed spectrum 818 only or from the licensed spectrum 816 only, or, as is depicted in the embodiment of FIG. 16, may comprise resources from the licensed spectrum 816 and from the unlicensed spectrum 820.

In accordance with embodiments, the wireless communication system may include a terrestrial network, or a non-terrestrial network, or networks or segments of networks using as a receiver an airborne vehicle or a space-borne vehicle, or a combination thereof. Further, the wireless communication system may by a system or network different from the above described 4G or 5G mobile communication systems, rather, embodiments of the inventive approach may also be implemented in any other wireless communication network, e.g., in a private network, such as an Intranet or any other type of campus networks, or in a WiFi communication system.

In accordance with embodiments of the present invention, a user device comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or a Wi-Fi device, like a station (STA), access point (AP), node or mesh node, or mesh point, or Mesh AP, or any sidelink capable network entity.

In accordance with embodiments of the present invention, a network entity comprises one or more of the following: a macro cell base station, or a small cell base station, or a central unit of a base station, an integrated access and backhaul, IAB, node, or a distributed unit of a base station, or a road side unit (RSU), or a Wi-Fi device such as an access point (AP) or mesh node (Mesh AP), or a remote radio head, or an AMF, or a MME, or a SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear, that these aspects also represent a description of the corresponding method, where a block or a device corresponds to a method step or a feature of a method step. Analogously, aspects described in the context of a method step also represent a description of a corresponding block or item or feature of a corresponding apparatus.

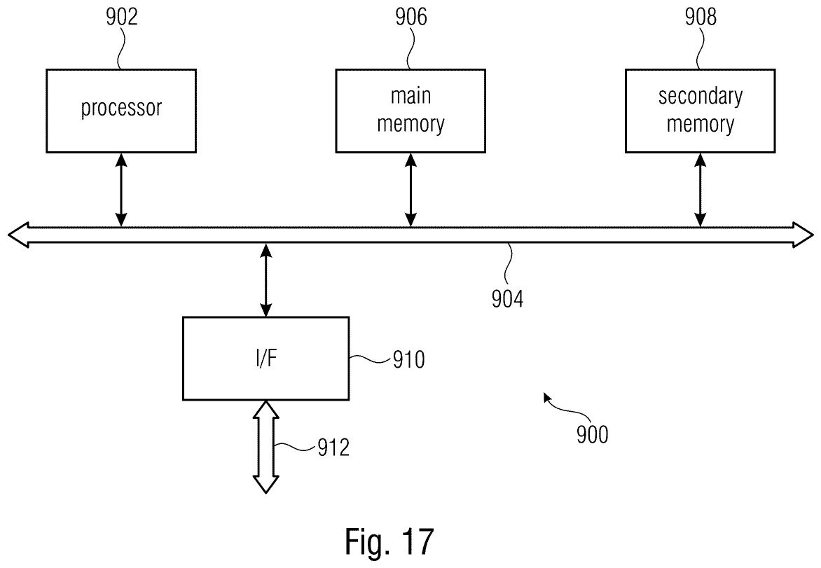

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 17 illustrates an example of a computer system 900. The units or modules as well as the steps of the methods performed by these units may execute on one or more computer systems 900. The computer system 900 includes one or more processors 902, like a special purpose or a general-purpose digital signal processor. The processor 902 is connected to a communication infrastructure 904, like a bus or a network. The computer system 900 includes a main memory 906, e.g., a random-access memory, RAM, and a secondary memory 908, e.g., a hard disk drive and/or a removable storage drive. The secondary memory 908 may allow computer programs or other instructions to be loaded into the computer system 900. The computer system 900 may further include a communications interface 910 to allow software and data to be transferred between computer system 900 and external devices. The communication may be in the from electronic, electromagnetic, optical, or other signals capable of being handled by a communications interface. The communication may use a wire or a cable, fiber optics, a phone line, a cellular phone link, an RF link and other communications channels 912.

The terms “computer program medium” and “computer readable medium” are used to generally refer to tangible storage media such as removable storage units or a hard disk installed in a hard disk drive. These computer program products are means for providing software to the computer system 900. The computer programs, also referred to as computer control logic, are stored in main memory 906 and/or secondary memory 908. Computer programs may also be received via the communications interface 910. The computer program, when executed, enables the computer system 900 to implement the present invention. In particular, the computer program, when executed, enables processor 902 to implement the processes of the present invention, such as any of the methods described herein. Accordingly, such a computer program may represent a controller of the computer system 900. Where the disclosure is implemented using software, the software may be stored in a computer program product and loaded into computer system 900 using a removable storage drive, an interface, like communications interface 910.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A user device, UE, for a wireless communication network,
wherein the UE is to communicate with one or more further UEs in the wireless communication network over a sidelink, SL,
wherein the UE is configured or preconfigured to support sidelink carrier aggregation, SL-CA, the SL-CA comprising a plurality of component carriers, CCs, and
wherein the UE is to select the CCs for the SL communication
in accordance with a configuration or pre-configuration of the SL-CA, and/or
based on inter-UE coordination, IuC, information indicating available/preferred or unavailable/not-preferred resources or a collision, e.g., collision indicator, CI.

2. The user device, UE, of claim 1, wherein the configuration or pre-configuration of the SL-CA indicates one or more of the following:
one or more properties of a given CC,
among the plurality of CCs one or more CCs containing a predefined signal or predefined information,
one or more CCs to be used for a predefined scenario.

3. The user device, UE, of claim 2, wherein the one or more properties comprise one or more of the following:
a center frequency of the given CC;
a bandwidth of the given CC,
a bandwidth part, BWP, to be used on the given CC,
a bandwidth class the given CC,
a fallback group
a numerology for the given CC,
a resource pool configuration for a given CC,
a cast type to be used on the given CC, e.g., a broadcast, a groupcast, a multicast or a unicast,
a service type to be used on the given CC,
a transmission priority to be used on the given CC,
whether feedback is enabled on the given CC, e.g., whether a feedback channel, like a Physical Sidelink Feedback Channel, PSFCH, is present on the given CC,
among the plurality of CCs one or more CCs to be used for a feedback in case a feedback, like a Physical Sidelink Feedback Channel, PSFCH, is not enabled on the given CC,
among the plurality of CCs one or more CCs being legacy CCs, that are monitored by legacy UEs,
a UE type to be used on a given CC, e.g., any of V2X-UE, IoT-UE, RSU, relay node,
an NR release type to be usable/allowed for a given CC, e.g., NR Release 17 V2X feature allowed and/or NR Release 18 features allowed, or whether this CC is only used for a certain 3GPP release type, e.g., Rel-16, in order to ensure backwards compatibility,
whether a UE can perform power saving, e.g., DRX or eDRX on the given CC or not, as well as a possible DRX configuration for the given CC,
whether IuC is enabled or disabled on the given CC,
whether the transmission and/or reception of wake-up signals (WUS) is enabled/disabled on the given CC,
whether positioning reference signals, e.g., PRS, can be transmitted on a given CC.

4. The user device, UE, of claim 2, wherein the predefined signal comprises one or more of the following:
a data signal,
a control signal,
a feedback signal,
one or more synchronization signals,
certain synchronization preambles for a re-synchronization, e.g., to be used in case the UE requires re-synchronization,
a wake-up signal (WUS),
a positioning reference signal (PRS),
a narrowband signal, e.g., a NB-IoT signal,
a beam management-related information,
a measurement signal, e.g., a signal containing channel state information, CSI, or channel quality related information.

5. The user device, UE, of claim 2, wherein the predefined information comprises one or more of the following:
an interference threshold for a given CC, e.g., a CBR threshold or a non-empty set of CBR thresholds valid for the one, some, or all CCs,
beam management information, beam maintenance information or beam recovery related information,
control information on a particular CC used for Uu, e.g., containing information in case the UE wants to switch from a Mode 2 operation to a Mode 1 operation or vice versa, or in case the UE wants to switch from SL to Uu or to a connection using a relay node, e.g., a Relay UE,
information related to a handover or to a conditional handover, CHO,
paging-related information,
discovery-related information,
broadcast-related information, e.g., a broadcast control channel,
IuC-related information, e.g., AIMs.

6. The user device, UE, of claim 2, wherein the configuration or pre-configuration of the SL-CA indicates among the plurality of CCs a proper subset of CCs containing the predefined signal or the predefined information.

7. The user device, UE, of claim 2, wherein the configuration or pre-configuration of the SL-CA indicates among N CCs, N being an integer, from 1 to up to N-1 CCs containing the predefined signal or the predefined information.

8. The user device, UE, of claim 2, wherein the configuration or pre-configuration of the SL-CA indicates among the plurality of CCs only one CC containing the predefined signal or the predefined information.

9. The user device, UE, of claim 2, wherein, when the configuration or pre-configuration of the SL-CA indicates one or more CCs to be used in a predefined scenario, one or more of the following is indicated:
CCs to be used dependent on a position of the UE,
CCs to be used dependent on the mobility state of the UE,
one or more CCs to be used in case the UE or a further UE with which the UE is to communicate over the SL is not able to transmit or receive on a certain CC,
one or more CCs to be used in case of a unicast link establishment by the UE.

10. The user device, UE, of claim 9, wherein the CCs to be used dependent on a position of the UE comprise one or more of the following:
CCs to be used dependent on a distance between the UE and a further UE with which the UE is to communicate over the SL, e.g., as defined in the minimum required communication range (MCR),
CCs to be used in a certain geolocation or zone,
CCs to be used dependent on a location of the UE in the wireless communication network.

11. The user device, UE, of claim 9, wherein the mobility state is one or more of
velocity of a UE,
mode 1 connectivity of a UE, e.g., connected to a certain gNB,
mode 2 connectivity of a UE,
height of a UE or 2D or 3D trajectory of a UE, e.g., in case the UE is a drone,
type of track, e.g., a UE moving on the Autobahn or on a dirt road, railroad track, water road,
a transition state, e.g., the UE performing a handover, e.g., HO or CHO, between gNBs, e.g., for UEs having a connectivity to eNB or gNB.

12. The user device, UE, of claim 1, wherein the UE is to receive the IuC information from one or more of the following:
one or more of the further UEs not being a communication partner of the UE for a certain SL communication,
one or more of the further UEs being a communication partner of the UE for a certain SL communication, e.g., a UE to/from which the UE transmits/receives over the SL,
a different transceiver in the device (in device coexistence), e.g., the device has internal an LTE and NR modem, or a WiFi modem and an NR modem, and the other UE device forwards this information internally to the UE,
a radio access network, RAN, entity, like a Road Side Unit, RSU, or a gNB or a relay node.

13. The user device, UE of claim 1, wherein the IuC-related information is valid and/or received within a selection window of the UE and/or the further UE.

14. The user device, UE, of claim 1, wherein the UE is to transmit IuC information to a further UE to do one or more of
inform the further UE about one or more future transmissions by the UE,
inform the further UE about resource collisions, e.g., caused by other transmissions,
inform the further UE about preferred resources or non-preferred resources, e.g., resources which are interference-free or which may cause interference to the UE,
request IuC information from the further UE,
a request for positioning information, e.g., a geolocation or reference signals, PRS,
a wake-up signal (WUS),
a mobility state,
a handover-related information, e.g., a handover configuration like a preferred set of gNBs, or a CHO configuration.

15. The user device, UE, of claim 1, wherein the UE is to transmit the IuC information on one or some or all CCs used by the UE.

16. The user device, UE of claim 14, wherein, the IuC information relates
only on the CCs on which the IuC information is transmitted, or
on one or more or all of the CCs where the UE has a future transmission.

17. The user device, UE, of claim 1, wherein
the UE is to acquire selected resources for a transmission by performing a resource selection based on a channel busy ratio, CBR, the resource selection comprising:
selecting resources for the SL transmission which are above a pre-defined or configured CBR-threshold, or
removing resources for the SL transmission which are below a pre-defined or configured CBR-threshold, and
responsive to receiving the IuC information, the UE is to
remove the received unavailable or not preferred resources from the selected resources, e.g., based on the non-preferred set of resources or based on the CI, or
add some or all of the received available or preferred resources to the selected resources.

18. The user device, UE, of claim 1, wherein the UE is operated in an out-of-coverage mode in which the UE
is not connected to a base station of the wireless communication system, e.g., the UE operates in Mode 2 or is not in an RRC connected state, so that the UE does not receive from the base station a sidelink resource allocation configuration or assistance, and/or
is connected to a base station of the wireless communication system, which, for one or more reasons, is not capable to provide a sidelink resource allocation configuration or assistance for the UE, and/or
is connected to a base station of the wireless communication system not supporting a sidelink service, like a NR V2X service, e.g., a GSM, UMTS or LTE base station.

19. The user device, UE, of claim 1, wherein the UE comprise one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, or a mobile terminal, or a stationary terminal, or a cellular IoT-UE, an industrial IoT-UE, HoT, or a SL UE, or a vehicular UE, or a vehicular group leader UE, GL-UE, or a scheduling UE, S-UE, or an IoT or narrowband IoT, NB-IoT, device, or a WiFi device or WiFi station, STA, or a ground based vehicle, or an aerial vehicle, or a drone, or a moving base station, or road side unit, RSU, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

20. A method for operating a user device, UE, for a wireless communication network, wherein the UE is to communicate with one or more further UEs in the wireless communication network over a sidelink, SL, and wherein the UE is configured or preconfigured to support sidelink carrier aggregation, SL-CA, the SL-CA comprising a plurality of component carriers, CCs, the method comprising:
selecting, by the UE, the CCs for the SL communication
in accordance with a configuration or pre-configuration of the SL-CA, and/or
based on inter-UE coordination, IuC, information indicating available/preferred or unavailable/not-preferred resources or a collision, e.g., collision indicator, CI.
